(19) United States
(12) Patent Application Publication
(10) Pub. No.: US 2026/0307657 A1
(43) Pub. Date: Oct. 8, 2026

(54) REAL-TIME DRIVING DATA INSIGHT SYSTEM AND METHOD WITH EDGE COMPUTING AND ARTIFICIAL INTELLIGENCE TOOLS

(71) Applicant: State Farm Mutual Automobile Insurance Company, Bloomington, IL (US)

(72) Inventor: Alexander Cardona, Gilbert, AZ (US)

(21) Appl. No.: 19/171,516

(22) Filed: Apr. 7, 2025

(51) Int. Cl. B60W 40/09; B60K 35/28; H04L 67/12

(52) U.S. Cl. CPC B60W 40/09; B60K 35/28; H04L 67/12; B60W 2556/45; B60W 2756/10

(57) ABSTRACT

Systems and methods for generating and displaying real-time driving information relating to operation of a vehicle, including: (i) receiving, via a network, real-time driving data derived from sensor data of sensors of a user computing device that is associated with a user operating a vehicle and configured to transmit the real-time driving data to an edge computing device; (ii) analyzing, using an artificial intelligence (AI) tool, the real-time driving data to determine a plurality of driving behaviors of the user; (iii) based upon the determined plurality of driving behaviors of the user, generating, via the AI tool and at the edge of the network, a plurality of real-time scores for the plurality of driving behaviors; and/or (iv) transmitting, via the network and at the edge of the network, score data corresponding to the plurality of real-time scores to at least one of the user computing device or the vehicle.

### FIELD OF THE DISCLOSURE

The present disclosure generally relates to vehicle safety and, more particularly, to systems and methods for obtaining and combining vehicle telematics data, vehicle insight data, and/or external data into individualized driving data associated with a driver, and analyzing the driving data using an artificial intelligence (AI) model to apprise the driver, in real-time, of safe driving behaviors determined by the model.

### BACKGROUND

Even with advancements in vehicle technology such as automated driving systems and technology, driving safety may continue to be a concern for drivers, passengers, pedestrians, and law enforcement, especially in connection with inexperienced drivers. While many vehicles may now include technology including, but not limited to, a global positioning system (GPS) and/or other onboard diagnostics that enable telematics-based monitoring of vehicles, current telematics models may be built on lag indicators. In other words, current telematics models may be based upon post-trip telematics that are derived after a trip in a vehicle has been completed. However, drivers may not very likely to review their telematics data after a trip. Even for short trips, it may be a challenge for drivers to be able to extrapolate and grasp what the telematics data of their vehicle reveals with respect to their driving style, and/or what major and/or minor changes could be made to alter their driving behaviors for improved safety.

At least some known telematics systems may not adequately convey telematics data to drivers in a timely manner so that drivers can understand and glean relevant information from the telematics data. Further, known systems and methods may not provide real-time telematics data to drivers in an easily understandable format, which may reduce the likelihood that drivers will actually review the telematics data, while at the same time may not aide a driver in make beneficial changes to their driving during an active driving session. Conventional techniques may also include additional inefficiencies, ineffectiveness, encumbrances, and/or other drawbacks, as well.

### BRIEF SUMMARY

The present embodiments may relate to, inter alia, systems and methods for obtaining and combining vehicle telematics data, vehicle insight data, and/or external data into individualized driving data associated with a driver, using an AI tool such as an AI model to analyze and/or predict driving behaviors in real-time based upon the driving data, and conveying results of the analysis to the driver to prompt the driver to alter their driving behavior for improved safety (or, if the driver is already driving in a safe manner, to maintain their current driving behaviors), wherein the results may be displayed or otherwise presented to the driver in an easily understandable way on a user interface. For example, telematics data may be reflective of a driving style of a user, vehicle insight data may include make, model, weight, stopping distance, safety features, etc. of the vehicle, and external data may include weather, and traffic/road conditions, etc.

To implement real-time analysis of the driving data, edge computing may be utilized to transmit and/or process real-time driving data to associated computing devices/systems, reducing latency and providing drivers with real-time safe driving scores, predictions, and/or suggestions regarding driving behaviors and/or their driving trip. The real-time driving data may be integrated as part of a software-based driving platform such as a safe driving software platform provided by an entity such as an insurance company, and embodied as a software application that may be installable on a mobile computing device of a user (e.g., a driver of the vehicle) such as a mobile phone, and the application may be configured to generate audiovisual information to apprise drivers of their driving style and other pertinent information, such as information regarding a current driving trip. For example, such a platform may generate safe driving scores and/or determine if drivers are eligible for benefits such as insurance rate discounts and/or other rewards, reductions, or policy changes based upon a history of safe driving. Such a safe driving platform and any corresponding safe driving discounts may be provided by insurance providers to insured drivers. The amount and extent of coverage, discounts, and/or other incentives of or associated with a given insurance policy may vary based upon make, model, size, and age of the vehicle, the driver's safe driving history, and/or other factors.

The safe driving platform may be configured as a real-time safe driving platform that may be implemented in part via a mobile device application that may be installable, for example, on the mobile phone of the driver, so that when the driver has their mobile phone with them in a vehicle, the application may be used to monitor driving, obtain telematics data and/or other data such as location data, and provide the various data to a computing device associated with the model for analysis. Results from the model analysis may be sent back to the mobile device for display to the driver via a graphical user interface of the safe driving application, permitting the driver to review the real-time analysis and other metrics relating to their driving behaviors and current trip. The real-time safe driving platform may also be incorporated with and/or provided via an entertainment system of the vehicle, also referred to as an infotainment system, and/or other visual and/or audible interfaces provided within a vehicle, such as a various other displays and/or speakers of a sound/audio system of the vehicle, and the like. For example, a graphical user interface of the mobile phone, or a vehicle-friendly version thereof, may be shared with or otherwise made available on a display screen of the entertainment/infotainment system of the vehicle.

Usage of the real-time safe driving platform within a vehicle may be realized via the driver operatively connecting their mobile phone to the entertainment/infotainment system via a wireless and/or wired communication protocol that may include a screen casting/screen mirroring feature and/or other software compatible with the entertainment/infotainment system, so that applications such as the safe driving application stored on the mobile phone may be duplicated and/or otherwise formatted for viewing and/or listening via a display screen and/or audio system of the vehicle. For example, the mobile phone may be connected to the entertainment/infotainment system via USB and/or Bluetooth, such that visual aspects of the mobile phone, such as the safe driving application stored on the mobile phone, may be displayable on the display screen of the entertainment/infotainment system via a USB connection and audio may be played via speakers of the sound/audio system of the vehicle via a Bluetooth connection. This may enable a driver to have access to real-time telematics data as provided via the safe driving application on their mobile phone while driving, to be apprised of pertinent information provided by the safe driving application, enabling a driver to make real-time changes to driving behavior based upon real-time safe driving scores and/or other suggestions provided via the safe driving application. Driving behavior information may be communicated to the driver via a scoring system provided in the application, where scores may be generated based upon an underlying scoring model that has been trained determine a correlation between data such as telematics data and safe driving behaviors. Additionally, or alternatively, the entertainment/infotainment system may include native functionality to allow for applications to be downloaded and executed on the entertainment/infotainment system and for collection of telematics data via a plurality of vehicle sensors without the need to be operatively coupled with a mobile device.

In one aspect, an edge computing device for generating, in real-time, driving behavior scores for display during driving sessions and for providing real-time driving alerts and suggestions to drivers may be provided. The edge computing device may be part of a computing system that may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, AI bots (e.g., ChatGPT), and/or other electronic or electrical components, which may be in wired or wireless communication with one another. The computing system may be an edge computing system, or a combination of sub-systems including edge sub-systems and other (e.g., non-edge) sub-systems. For instance, in one example, the edge computing device may be one of a plurality of edge computing devices in network communication within a network, and may include at least one processor in communication with at least one memory device. The at least one processor may be programmed to: (1) receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and/or (ii) configured to transmit the real-time driving data to the edge computing device via the network; (2) analyze, using at least an artificial intelligence (AI) tool, the real-time driving data to determine a plurality of driving behaviors of the user; (3) based upon the determined plurality of driving behaviors of the user, generate, via the AI tool and at the edge of the network, a plurality of real-time scores including a real-time score for each driving behavior of the plurality of driving behaviors of the user; and/or (4) transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle. The computer system may be programmed to direct additional, less, or alternate functionality, including that discussed elsewhere herein.

In another aspect, a computer-implemented method for generating, in real-time, driving behavior scores for display during driving sessions and for providing real-time driving alerts and suggestions to drivers may be provided. The method may be implemented using one or more local or remote processors, servers, transceivers, sensors, memory units, augmented reality glasses or headsets, virtual reality headsets, extended or mixed reality headsets, smart glasses or watches, wearables, voice bot or chatbot, AI bot (e.g., ChatGPT), and/or other electronic or electrical components, which may be in wired or wireless communication with one another. For instance, in one example, the computer-implemented method may be performed by an edge computing device of a plurality of edge computing devices in network communication in a network, and the edge computing device may include at least one processor in communication with at least one memory device. The method may include: (1) receiving, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and/or (ii) configured to transmit the real-time driving data to the edge computing device via the network; (2) analyzing, using at least an artificial intelligence (AI) tool, the real-time driving data to determine a plurality of driving behaviors of the user; (3) based upon the determined plurality of driving behaviors of the user, generating, via the AI tool and at the edge of the network, a plurality of real-time scores including a real-time score for each driving behavior of the plurality of driving behaviors of the user; and/or (4) transmitting, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle. The method may include additional, less, or alternate functionality, including that discussed elsewhere herein.

In yet another aspect, at least one non-transitory computer-readable storage media having instructions stored thereon, where the instructions cause the generation, in real-time, of driving behavior scores for display during driving sessions and the providing of real-time driving alerts and suggestions to drivers may be provided. The instructions may be executed by one or more local or remote processors, servers, transceivers, sensors, memory units, augmented reality glasses or headsets, virtual reality headsets, extended or mixed reality headsets, smart glasses or watches, wearables, voice bot or chatbot, AI bot (e.g., ChatGPT), and/or other electronic or electrical components, which may be in wired or wireless communication with one another. For instance, in one example, the computer-executable instructions, when executed by at least one processor in communication with at least one memory device of an edge computing device of a plurality of edge computing devices in network communication in a network, may cause the at least one processor to: (1) receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and/or (ii) configured to transmit the real-time driving data to the edge computing device via the network; (2) analyze, using at least an artificial intelligence (AI) tool, the real-time driving data to determine a plurality of driving behaviors of the user; (3) based upon the determined plurality of driving behaviors of the user, generate, via the AI tool and at the edge of the network, a plurality of real-time scores including a real-time score for each driving behavior of the plurality of driving behaviors of the user; and/or (4) transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle. The instructions may direct additional, less, or alternate functionality, including that discussed elsewhere herein.

Advantages will become more apparent to those skilled in the art from the following description of the preferred embodiments which have been shown and described by way off illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a schematic diagram illustrating an exemplary system for generating a real-time telematics data using an AI model that analyzes user driving data to determine safe driving activity in accordance with an exemplary embodiment of the present disclosure.

FIG. 2 illustrates a diagram of an exemplary computing system included in the system shown in FIG. 1.

FIG. 3 illustrates a diagram of an exemplary interface that may be displayed by the computing system illustrated in FIG. 2.

FIG. 4A illustrates a diagram of an exemplary AI model that may be generated and deployed by the system shown in FIGS. 1 and 2.

FIG. 4B illustrates a diagram of an exemplary implementation of the model shown in FIGS. 1, 2, and 4A.

FIG. 4C illustrates a diagram of an exemplary implementation of generative and/or predictive outputs from the model shown in FIGS. 1, 2, 4A, and 4B.

FIG. 5 illustrates an exemplary configuration of a computing device that may be used in the exemplary computer system illustrated in FIG. 2.

FIG. 6 illustrates an exemplary configuration of a server device that may be used in the exemplary computer system illustrated in FIG. 2.

FIG. 7 illustrates an exemplary configuration of a user computing device that may be used in the exemplary computer system illustrated in FIG. 2.

FIG. 8 illustrates a flow chart of an exemplary computer-implemented process for determining generating and training a model using the computer system shown in FIG. 2.

FIG. 9 illustrates a flow chart of an exemplary computer-implemented process for determining driving behavior using the exemplary computer system shown in FIG. 2.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for obtaining and combining individualized driving telematics data, vehicle insight data, and/or external data, and using an AI model and/or edge computing to communicate real-time driving scores and/or driving suggestions to a driver of a vehicle, wherein the driving scores and/or suggestions provide an indication as to how well (e.g., safe) the driver is currently driving and whether there are current steps the driver can take to improve the overall score of their driving and/or individual categories included within the overall driving score.

Currently, vehicle telematics systems are based upon lagging indicators relating to past driving sessions, and do not adequately convey telematics data to drivers in a timely manner so that drivers can understand and glean relevant information from the telematics data in real-time, such as during a live driving session.

Systems and methods for obtaining and combining individualized vehicle telematics data, vehicle insight data, and/or external data for analysis by an AI model to generate safe driving information for conveyance to drivers are described herein and shown in the respective Figures. For example, telematics data may be reflective of a driving style of a user, vehicle insight data may include make, model, weight, stopping distance, safety features, etc. of the vehicle, and external data may include weather, and traffic/road conditions, etc. The AI model (which may also be referred to herein as an AI tool, as being part of the AI tool, and/or as the “model”/“models”) may be provided on or in association with a real-time telematics (RTT) computing device, and may analyze the driving data to generate safe driving scores, predict driving behaviors, and/or make safe driving suggestions in real-time for consideration by a driver. The driver may make real-time changes to their driving behaviors during a current trip based upon the scores/predictions/suggestions to improve safety.

In the exemplary embodiment, a software application (e.g., safe driving application) providing formatted results of outputs from the model may be installable/installed and/or otherwise available to operate on and/or be displayed on a user computing device such as a mobile phone of the user, and the mobile phone may be in operative connection and/or communication with the entertainment/infotainment system so that the verbatim graphical user interface of the application, or a modified version thereof, may be displayed on a display screen of the entertainment/infotainment system. To implement and realize real-time analysis of the driving data, edge computing may be utilized to receive, transmit, and/or process real-time driving data and other data to associated local computing devices/systems, reducing latency and enabling drivers to be provided with real-time safe driving scores, predictions, and/or suggestions regarding driving behaviors and/or their driving trip. By utilizing the various edge computing techniques described herein, the system is able to process and determine in real-time driving scores that may be displayed or otherwise presented to a driver along with alerts and/or suggestions on how to improve the driving scores to maximize the safety of the driving trip.

The information displayed on a display via the safe driving application may apprise the driver of pertinent safe driving information, enabling a driver to make real-time changes to their driving behavior. Safe driving information may include driving behavior information that uses a scoring system for a plurality of driving categories that may include, but are not limited to, braking, speed, acceleration/deceleration, turning (e.g., cornering), eye-tracking, distance between other vehicles and/or objects, steering of vehicle, autonomous features being used or not used (e.g., active or not active), and other categories such as distracted driving. The scoring system may be generated based upon an underlying scoring model that has been trained to determine a correlation between data such as telematics data and safe driving behaviors. Scores of the scoring system may be provided in an easily understandable format for ease of conveying “good” and/or other scores to drivers, to improve the likelihood that drivers will understand the scores and how to make changes to their driving behavior to increase their scores for improved safety while driving.

The AI model may be configured as part of the safe driving platform and may be configured to generate both predictive and/or generative outputs. The AI model may be configured to utilize machine learning (ML) to analyze and detect patterns and/or other trends gleaned from prior driving data to generate predictive outputs for future driving sessions, including during a current/live/real-time driving session. The AI model may therefore also be referred to herein as an AI/ML model or more generally as an AI/ML tool. The AI/ML model may further generate various generative outputs, such as text-based outputs, by using natural language processing to generate prompts, indications, and/or other messages for display and/or communication to drivers. Such text-based generative outputs may be conveyed in written and/or audible form to drivers. The AI/ML model may further be configured as a mixed modal generative system, capable of generating outputs combining multiple data types that may include not only text, but also images, audio, and/or video. For example, the AI/ML model may be configured to utilize camera outputs from onboard cameras of a vehicle and/or other cameras such as traffic cameras to generate new images/videos/animations that may be of value in instructing the driver on improved safe driving techniques. As one example, in the context a driver that consistently takes turns at too high of a speed, the AI/ML model may be able to provide a generated image/video/animation using the various camera outputs to illustrate to the driver how to better take a turn at a safer speed. In operation, this may include the software application displaying a clickable “Suggestion” icon on a display of the vehicle that when clicked by the driver (e.g., while not actively driving), displays a generated animation that visually illustrates how the driver can implement safer turning techniques (e.g., which may include visual examples of braking, steering, safe speed ranges when turning, etc.). The AI/ML model may be one or more AI/ML models, one unitary model, and/or combinations of one or more models. For example, the models may be configured as dedicated generative models and dedicated predictive models that may be kept isolated from one another or be combined with one another. The predictive models in particular may be substantially based upon ML systems, methods, and techniques.

Another output of the AI/ML model may be the real-time driving scores described herein, for display to a driver during a live driving session, where the real-time driving scores may represent a real-time grade that grades a safety level of the driver's various driving techniques (e.g., braking, speed, etc.). The AI/ML model may be trained on a variety of data sets including but not limited to driving, traffic, insurance, and/or driving instruction data and programmed to generate a score that, taking into account what may be learned from the training data, has a high correlation to safe driving techniques. The AI/ML model may be programmed based upon a plurality of underlying rules and/or algorithms that take into account the safe driving principles and/or techniques learned from the training data. As one example of how the trained/built AI/ML model may generate real-time scores that correspond to real-time data of an active driving session, the AI/ML model may be receive input data from the vehicle indicating that the vehicle is traveling on an interstate highway with a posted speed limit of 65 mph, but that the vehicle is travelling at a speed that is 85 mph, which is 20 mph over the posted speed limit, and, based upon braking and/or acceleration data, that the vehicle is making frequent lane changes. Taking into account all of these factors, the AI/ML model may determine that the driver is not driving in a safe manner, as the data suggests that the vehicle is weaving in and out of lanes of the interstate highway at high speeds. The AI/ML model may generate so-called “low” real-time scores for each category including braking, speed, and/or acceleration indicating that the driver is not adhering to safe driving techniques for the various categories. The scoring may be based upon a scoring scale of 0-100, although other scoring scales may be implemented. With respect to the AI/ML model, the scores output from the model may be based upon various weighting and/or other parameters utilized in the model. For example, a score on the lower end of the 0-100 scale (e.g., 30/100) may correlate to a certain weight in the model indicative of unsafe driving, whereas a score on the higher end of the 0-100 scale (e.g., 85/100) may correlate to a certain weight in the model indicative of safe driving. As such, the scores presented to the driver are so-called “user-friendly” scores that may be based upon a familiar grading scale such as 0-100, but where the scores actually correlate to underlying scoring aspects of the AI/ML model, as described herein.

In at least some embodiments, historical user data may be used to build the AI/ML model (which may also be referred to herein as simply the “model”) to analyze current user data, and then the model may be used to determine real-time driving behavior scores for communication to a driver of a vehicle based upon the current user data. In one of the exemplary embodiments, the historical user data may include sensor (e.g., telematics) data, vehicle data (e.g., make, model, weight, stopping distance, safety features, etc.), location data such as from one or more GPS's, environment data, and/or external (e.g., third-party) data such as data from third-party entities that may provide services relating to weather traffic/driving conditions. Third-party data may also include, for example, data from traffic cameras and the like, which may capture ambient speed of traffic on interstate highways and/or other roadways, etc. In some embodiments, the RTT computing device may be owned/operated/provided by or otherwise associated with an insurance provider or another service provider that provides services to users/drivers. In at least some embodiments, an insurance policy or adjustments to an insurance policy may be provided based upon a user's telematics data and corresponding driving behavior scores.

In the exemplary embodiment, RTT computing device may retrieve historical user data from a database in communication with RTT computing device. The database may be operated/owned/provided by an insurance provider associated with the safe driving platform, and may store historical data of insurance customers, as well as a variety of other data that may or may not be specific to the insurance provider and/or customers. The historical user data may include, for example, personal data (e.g., demographics data), historical telematics sensor data (e.g., generated by telematics sensors included within or in communication with user computing devices), historical location data (e.g., from a GPS sensor and/or other location sensors included within or in communication with user computing devices), historical insurance data (e.g., associated with insurance policies held by users and associated premiums of the insurance policies and any insurance claim data), and/or historical third-party data (e.g., weather data, traffic data, etc.). The scores and/or other determinations made by the model may also take into account seasonal weather issues, and may make adjustments based upon the differences between driving conditions in the various seasons of the year, such as summer driving versus winter driving. The model may output generative data that includes contextual analysis of a given driving behavior relative to current driving conditions that provides context between a status of a driving behavior and current driving conditions or other present conditions.

The model may be implemented for a particular candidate user in view of the historical data used to build/train the model. For example, using the candidate user's data (e.g., geolocation and/or telematics data) with the model that has been generated based upon other users' historical data, the scoring provided to the candidate user may be more precise and relevant to the particular user. Additionally, any predictions and/or generative outputs from the model may be more precise and relevant to the particular user and their particular driving scenario. For example, based upon traffic reports and a projected trajectory and/or destination of the user's vehicle, the model may determine that the user will be approaching congested traffic within the next 30 minutes and may generate predictive, customized information regarding the predicted slowdown, which may include customized visual (and/or audible) alerts for display to the user via a display screen of the user computing device and/or on a display screen native to the vehicle, such as an entertainment/infotainment system display screen. Additionally, based upon a user's historical driving behavior, the model may know that the user more often than not has low scores in the category of braking and distracted driving. In view of the forecasted congestion in traffic, the model may both warn the driver of the upcoming slowdown in traffic, and generate a reminder to the driver to be mindful of their braking and distracted driving. For example, because congested traffic may include stop-and-go operation of the vehicle, the model may ascertain that unsafe braking and unsafe distracted driving behavior could further increase the likelihood of an accident in such a stop-and-go traffic scenario. As such, predictive warnings and/or generative suggestions may take into account not only generalities associated with certain traffic scenarios (e.g., congested traffic) but also specific driving behavior characteristics of the driver.

In some embodiments, certain autonomous safety features may be automatically activated for this driver before entering the stop-and-go traffic area to help improve the safety of the driver, including safe distance systems and automatic braking systems. For example, based upon prior braking and/or safe distance scores, the model may cause autonomous safe distance autonomous braking features to be activated so that the driver need not perform such tasks themselves. The activation of such autonomous features may be accompanied by one or more indicators to apprise the driver of the activated autonomous features, including visual and/or audible indicators. For example, a status symbol may display on a display screen to apprise that driver that autonomous features are activated, and an audible message (e.g., a generative AI message) may be played through speakers of the vehicle for the driver to hear, such as “Autonomous braking engaged,” and similarly for when autonomous features are deactivated/disengaged.

In some embodiments, certain autonomous safety features may be automatically activated for a driver based upon what the AI model has learned about each driver. This may include, for a future or subsequent driving session, automatic activation of autonomous control features that correlate to driving categories and/or driving behaviors that a driver has historically struggled to achieve sufficient scores for. In doing so, this may help a driver to better understand and/or learn improved driving techniques for such categories and/or behaviors and improve their own driving ability and future scores. For example, when the vehicle is first started for a new driving session, the driver may be identified/recognized (e.g., via their user computing device or some other identification technique), and one or more autonomous control features may be automatically activated at the start of the new driving session based upon historical information (e.g., score data, etc.) associated with the driver. An output from the AI model regarding the particular driver and their historical scores may be utilized to determine which autonomous control features to automatically activate for each new driving session. This automatic activation may continue until the driver shows sufficient improvement in the various driving categories and/or driving behaviors. For example, for a sample driver that has been shown to struggle with adequate braking and proper adherence to speed limits, autonomous braking and autonomous speed control may be activated at startup for new driving sessions. Over time, as new braking and/or speed data is obtained during driver-controlled (e.g., non-or partially-autonomous) driving sessions, the AI model may determine that it is no longer required to have autonomous braking control (or other autonomous control features) activated at startup because the driver has been obtaining sufficient scores. Similarly, such autonomous control features may be caused to be re-activated at startup at a later date if a driver's scores again begin to drop to insufficient levels. Thus, the determination of whether to automatically activate the various autonomous control features at vehicle startup for subsequent driving sessions may fluctuate over time based upon analysis of new and/or shifting driving data of the driver and score results.

Once the historical user data has been analyzed and RTT computing device has generated and trained the model(s), current user data associated with a candidate user may be inputted into the model to determine safe driving scores and/or an insurance policy and associated premium, or adjustments thereto, for the candidate user based upon the current user data. The current user data, like the historical user data, may include, for example, telematics sensor data, location data, insurance data, and/or external (e.g., third-party) data. RTT computing device, using the model, may determine which cluster the candidate user fits into based upon the current user data and generate scores and/or an insurance policy and associated premium, or adjustments thereto, based upon the cluster of the user. Using the above examples, if RTT computing device determines, through analysis of the current user data, that the candidate user residing in the Midwest is a 30 year old driving a large SUV or truck, and RTT computing device may generate an insurance policy and associated premium accounting for the candidate user's predicted driving behavior, which may include a decreased likelihood of distracted driving, but still may need a longer braking distance due to the size of the vehicle.

The AI/ML model may include one or more models, merged models, etc., as described herein. For example, there may be individual models for vehicle-specific aspects such as braking, weather models, traffic models, insurance models, etc., and aspects of each of these models may be utilized to create one or more unified models that may take into account the weights and/or layers of the multiple different models. Unified models may take the strengths of each individual model to produce a more robust and powerful overall model, which may then be used to improve performance on a specific task without, for example, needing to train a new model from scratch. RTT computing device may generate, using the historical user data, a model that first determines various categories of driving behavior including braking, accelerating/decelerating, turning (e.g., cornering), speed, and/or distracted driving based upon historical user data, and then determines safe driving thresholds for these categories. The model may then determine driving behavior scores correlating to the safe driving thresholds, and generate predictive analysis and/or generative outputs for relaying to a driver. The model(s) may also be used to determine insurance policies and/or associated premiums, or adjustments thereto, for users, based upon determined scores. In other words, the historical user data may be used to build the model that may then be applied to current input data to generate an output.

In one exemplary embodiment, tasks such as data processing and analysis of real-time data may be performed by the RTT computing device (which may be configured to function as a modeling server and more generally as a modeling computer system), which may include utilizing nearby edge computing devices and/or networks to reap benefits such as reduced latency in data processing and/or transmissions. In doing so, current user data for a user may be inputted into the model, and the model may be trained to output customized scores, predictive and/or generative information such as suggestions for improving safe driving or avoiding risky driving conditions/situations, and/or a customized insurance policy and associated premium, or adjustments thereto, for the user based upon driving behavior scores of the user, such as providing insurance discounts or other cost savings to the user, or otherwise lowering the premium for the user. That is, the user-specific precise and relevant outputs of the model may be applied to any insurance policy and associated premium, or adjustments thereto, offered to the user, which may likewise be more precise and relevant to the particular user. In another exemplary embodiment, these tasks may be performed by one of more edge computing devices, with no or minimal communications needed between the edge computing devices and the RTT computing device. For example, the RTT computing device may primarily be utilized for initial models training, and/or updating/re-training the model, whereas the edge computing devices may primarily be utilized to operate the model at the edge on live data as described herein. The edge computing devices may periodically “phone home” to central computers such as the RTT computing device, for example to provide batches of newly acquired data to the RTT computing device, so that the RTT computing device can use the new data for any variety of purposes relating to the model (e.g., to see if the model is still generating accurate results on new data, to see if there are any new trends in the data, etc.).

Moreover, in embodiments where insurance coverage may be offered or updated based upon data in the safe driving platform, the edge computing devices and RTT computing device may also be utilized. For example, any associated insurance policy and associated premium, or adjustments thereto, can be offered based upon minimal data (e.g., a user's opt-in and user data automatically retrieved from a user computing device of or associated with the user such as through an application operating on the user computing device and configured to capture the user data), which may accelerate and/or otherwise make an underwriting or policy-offer process more efficient. That is, instead of an insurance provider having to investigate each user requesting to be covered by an insurance policy individually, as in conventional systems, an insurance policy and associated premium, or adjustments thereto, may be generated by RTT computing device or edge computing devices based upon minimal user input.

Additionally, RTT computing device may analyze, using the generated model(s), the historical user data to cluster users based upon other data that may include residence location (e.g., by cities, neighborhood, street ranges, etc.) and/or vehicle types and other characteristics for users of each cluster. For example, RTT computing device may determine, based upon the model, that users in the Midwest of the United States almost exclusively commute to work using their personal vehicles (e.g., not public transportation), and that their vehicles are, on-average, larger than vehicles driven by users on the East and/or West coasts of the United States. RTT computing device and the generated model may analyze safe driving behavior relative to vehicle type, for example vehicle size. For example, a safe score for an appropriate braking response/time for a smaller vehicle may be calculated using different metrics than a safe score for an appropriate braking response/time in a larger vehicle that may take longer to stop. Accordingly, the model may be trained to determine that users with larger vehicles may need insurance policies that are more tailored to cover accident types that are more closely linked to braking maneuvers, while users with smaller cars that may be faster (e.g., sports cars) may need insurance policies that are more tailored to cover accidents that are more closely related to vehicle speed.

Further, the RTT computing device and the generated model(s) may analyze distractions within the vehicle and risks associated with distracted driving behavior of the users of each cluster and use the quantified likelihood of damage in the generation of insurance premiums associated with insurance policies. The distracted driving behavior of a user may be associated with the driving habits of the user for a plurality of trips. For example, the distracted driving behavior of a teenage driver may include one or more of active usage of a mobile phone while driving, such as sending text messages to friends while driving, listening to music at a loud volume and/or having loud conversations, and/or the presence of multiple friends/passengers, and additional mobile phones, in the vehicle. The RTT computing device may determine that teenage drivers, for example, have a higher distracted driving likelihood than other age ranges of drivers such as older drivers, and therefore have a higher risk compared with older drivers. The RTT computing device may determine, using the model(s), that high risk driving behavior includes active usage of a mobile phone while driving, loud music, loud conversations, and the presence of additional mobile phones in the vehicles that may belong to friends, while lower risk driving behavior (e.g., safer driving behavior) may include less overall noise within the vehicle interior and less active usage of a mobile phone while driving. Accordingly, the premiums associated with the insurance policies of users having high risk driving behavior may be higher as compared to premiums for users having lower risk driving behavior.

For example, the RTT computing device may determine, using the model(s), that users in the age bracket of 16-24 years may need insurance policies that are more tailored to cover distracted driving aspects. In the case of a teenage driver, the model(s) may mirror having a more experienced driver such as a parent or driving instructor in the vehicle with the teenage driver, providing feedback as they drive, as opposed to conventional systems that are only capable of providing after-the-fact analysis of driving behavior. Accordingly, the RTT systems and methods described herein may be of great value to the parents of teenage drivers. Moreover, the RTT systems and methods described herein may reduce claims and losses for drivers in all age groups and experience levels by way of the predictive and generative outputs of the model in real-time driving sessions. The RTT systems and methods described herein are applicable to commercial driving aspects as well, and may improve the safety of fleets of vehicles including delivery fleets, taxis/ride-shares, etc., as well as autonomous vehicles.

Further, RTT computing device may adjust a generated insurance policy and associated premium, or adjustments thereto, based upon further analysis of the current user data. For example, a user may adjust their driving behavior to be safer based upon feedback provided by real-time scores over a period of time, in order to obtain a lower insurance premium and/or other account benefits, such as an account incentive for safe driving. If RTT computing device determines that the candidate user consistently exhibits high scores across all safe driving categories, RTT computing device may determine a different cluster that better fits the driving behavior of the candidate user and/or customize the insurance policy and associated premium of the candidate user independent of the clusters of RTT computing device.

It should be understood herein that while the scoring and/or insurance policy and associated premiums, or adjustments thereto, may be generated based upon the most common driving behaviors or the predicted driving behaviors for the candidate user, the scores and/or insurance policy may cover any driving behaviors that the candidate user exhibits. For example, even if the candidate user rarely exhibits distracted driving and therefore the likelihood of damage resulting from distracted driving is not a major factor in the determination of the premium associated with the candidate user's insurance policy, the candidate user would still be covered by the insurance policy if the user exhibits distracted driving behavior in a fleeting circumstance.

In some embodiments, the candidate user data may be captured during a trial period where the candidate user data is captured by a user computing device for a trial period of time and then analyzed by the RTT computing device. The RTT computing device may identify the cluster that the user should be placed in based upon the data captured during the trial period. For example, the user computing device of the user may have the software application stored thereon that may be configured to gather telematics data of the user while the user is driving, and then communicate the captured telematics data back to the modeling computer device for input into the model. This gathering and transmission of data may be done with no input from the user, other than loading the application on the user phone. Thus, with no other input from the user, the telematics data of a user may be collected and entered into the model such that an output of driving behaviors and/or a type of insurance policy with premium calculated can be electronically sent to the user for display on the user device (e.g., using the application). The user only then needs to click or otherwise accept the policy, and coverage is issued. For example, a prompt corresponding to the offer may include a single button (e.g., a virtual button) displayed on the user computing device and/or a display such as an in-vehicle display mirroring the user computing device, such that the user can select the button by clicking or tapping (e.g., “one-touch”) and by so doing, the user accepts the determined insurance policy and is enrolled in the policy.

In some embodiments, the RTT computing device may collect users' data for different time intervals in order to determine changes in the users' driving behavior. The RTT computing device may apply the model to candidate user data collected during a validation time period to determine a user validation driving behavior. The RTT computing device may execute the model and use the candidate user data collected during a validation time period as inputs into the model, where the executed model will output the user validation driving behavior. The RTT computing device may compare the user trial driving behavior with the user validation driving behavior to complete a validation process. In other words, the RTT computing device compares the user trial driving behavior with the user validation driving behavior to confirm that the user's driving behavior has not changed. The trial period of time may include a first-time interval and the validation period includes a second time interval generally occurring after the first-time interval. Accordingly, the RTT computing device may be able to monitor the driving behavior of the user and make adjustments to the user's insurance plan and premiums based upon changes in the user's driving behavior. In some embodiments, the validation may occur using the application stored on the user computing device.

The RTT computing device may transmit a notification to a user computing device of the candidate user that includes driving behavior scores in various driving behavior categories and/or the insurance policy and associated premium, or adjustments thereto, generated for the candidate user by RTT computing device. In some embodiments, the notification may include a visual prompt on a display screen of the vehicle being driven by the user. In other embodiments, the notification may include a pre-populated registration form that easily allows (e.g., with “one-touch” or voice command, or some other acknowledgement) the candidate user to register for the insurance policy and immediately begin receiving coverage after registration, and/or accept awards or discounts rewarded for recognized safe driving behaviors and high scores. In some embodiments, the RTT computing device may generate the insurance policy and associated premium for the candidate user in response to an insurance inquiry from the candidate user. In other embodiments, the RTT computing device may generate the insurance policy and associated premium automatically (e.g., without user input) as part of an advertising or marketing campaign for an insurance company. Edge computing devices may, in addition to or instead of the RTT computing device, perform the various computing tasks described herein relating to the generation of the real-time scores and other generative/predictive outputs from the model. Put another way, except for tasks that are more suitable for RTT computing device to perform, such as initial model training and the like, edge computing devices may effectively be used in place of the RTT computing device.

As used herein, insurance “coverage” includes any insurance policy that reimburses and/or pays for physical and material damages resulting from a collision or accident involving a user covered by the insurance policy.

“App,” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof.

“Telematics data,” as used herein, may refer generally to data associated with monitoring a moving computing device. Telematics data may incorporate location, movement (e.g., speed, direction, acceleration, braking, cornering, GPS location, heading, route, etc.), and condition (e.g., “on”, “off”, in-motion, etc.) data based upon a plurality of sensors on-board the computing device and/or connected to the computing device. Accordingly, where the computing device is associated with a vehicle, the telematics data may be associated with monitoring the vehicle. Where the computing device is a user computing device such as personal mobile computing device, for example a mobile phone such as a smart phone, the telematics data may be associated with monitoring the personal mobile computing device. In at least some cases, the personal mobile computing device may be used to capture vehicle telematics data, where the personal mobile computing device is present in/on a vehicle during motion/use of the vehicle.

In some cases, the personal mobile computer device includes an accelerometer that provides telematics data. In other cases, the personal mobile computer device includes a GPS that provides location and movement information. In still further embodiments, the personal mobile computer device connects to a vehicle that the user is traveling in, such as via Bluetooth or Near Field Communication (NFC) or by connecting to a Wi-Fi connection provided by the vehicle. In these further embodiments, the personal mobile computer device may be able to receive telematics data from the vehicle and/or to identify the vehicle that the user is traveling in conjunction with data of edge computing devices. In some cases, this telematics data is collected by the user mobile computing device using an app stored thereon.

“Edge computing,” as used herein, may refer generally to situating compute resources, logic, and/or data storage closer to the devices where data may be being gathered and/or used, to reduce latency issues, and improve an application's ability to provide data in real-time.

“Sensor data,” as used herein, may refer generally to data captured by sensors. Sensor data may be associated with the movement of a computing device. Sensor data for a vehicle may also include data that captures movement of occupants of the vehicle, which may not affect the motion of the vehicle. In some cases, telematics data may include sensor data, where data may be sent in packets that include data from all sensors associated with a computing device (e.g., both motion and non-motion sensor data). Detected light and sound may also be included in sensor data. Sensor data may also include data not obtained from movement being sensed.

Additionally, the providing of real-time telematics information and corresponding driving behavior scores provides effectively instant feedback to the user/driver, and helps users/drivers better understand their own driving tendencies in a dynamic manner. For example, a driver can see in real-time the impact on their braking score by changing their braking style to be smoother and initiating braking at safer distances. This may increase the likelihood that a driver can accurately identify and change unsafe driving behavior, via the instant feedback provided by the RTT systems and methods described herein.

### Exemplary Real-Time Telematics System

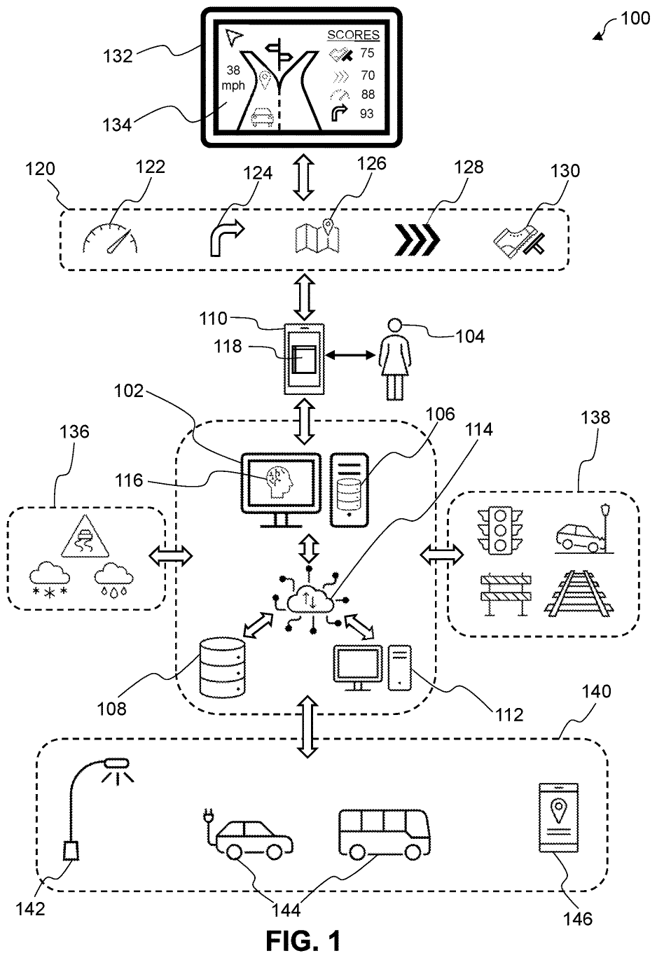

FIG. 1 illustrates a schematic diagram illustrating an example system 100 in accordance with an exemplary embodiment of the present disclosure. In the exemplary embodiment, system 100 may include a real-time telematics (RTT) computing device 102 that may be implemented to (i) receive user data which may include telematics data, vehicle insight data, and/or other external data (collectively referred to herein as “driving data”), (ii) generate one or more models to analyze driving data of users 104 and output scores for a variety of categories of driving behavior to apprise a driver of their driving style, and/or (iii) generate and output, via the one or more models, predictive and/or generative outputs to provide warning to and/or otherwise convey to the driver various information relating driving routes, driving analytics, etc. System 100 is one non-limiting representation of a safe driving platform as described herein.

In the exemplary embodiment, RTT computing device 102 may include one or more memory devices 106. In one example exemplary embodiment, the one or more memory devices 106 may include a server and/or database (e.g., a server/database). RTT computing device 102 may be in operative communication with one or more other servers/databases 108 (or other memory devices), user computing devices 110, and/or client computing devices 112 via a network 114. Server/database 106 may be in operative communication with one or more of server/database 106 that may each store data such as user data. RTT computing device 102 may be in operative communication with a plurality of user computing devices 110 and/or client computing devices 112 to obtain and store user data and generate one or more models 116 to analyze user data and determine driving scores, and generate and output predictive and/or generative outputs relating to a driving session. RTT computing device 102 may generate models 116 based upon historical user data associated with a plurality of users, as well as individualized, user-specific models 116, and/or merged models 116 that are based upon both individualized and group data.

In the exemplary embodiment, user computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices, and may include sensors that may include telematics sensors (e.g., an accelerometer, a GPS, a microphone, a barometer, a temperature sensor, and/or a gyroscope) and may transmit telematics data (e.g., location, speed, and other relevant data related to movement of users) to RTT computing device 102 or other devices such as edge computing devices. A user computing device 110 may, without limitation, include one or more processors, memory devices, a display screen (e.g., a touch screen), and/or an audio system including a microphone and/or speakers. Telematics data may be generated from onboard vehicle sensors and/or systems as well, which may include an accelerometer, a GPS, a microphone, a barometer, a temperature sensor, impact detection sensors, ultrasonic sensors, cameras, a lidar system, a radar system, a computer vision system, drone outputs, and/or a gyroscope.

In the exemplary embodiment, client computing devices 112 may be computers that include a web browser or a software application, which enables client computing devices 112 to access remote computer devices, such as RTT computing device 102, using network 114, which may include the Internet or other networks as described herein. More specifically, client computing devices 112 may be communicatively connected RTT computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular network connection, a satellite connection, and a cable or fiber modem. In some embodiments, client computing devices 112 may be configured in a distributed or parallel computing configuration to provide parallel processing in connection with the training of models 116 and other aspects associated with the creation, updating, re-training, and/or deployment of models 116. In other embodiments, client computing devices 112 may be third-party computing devices associated with third-parties, and may be referred to herein as third-party computing devices. Client computing devices 112 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment, an application (app) 118 may be installed on user computing device 110 (e.g., a mobile device of user 104) and may provide a graphical user interface (GUI) and display results of the analysis by model 116 of telematics data and other data, which may include various driving information to be conveyed to user 104 via the GUI. App 118 may process telematics data 120 based upon data received from sensors onboard user computing device 110 (e.g., an accelerometer, a global positioning system (GPS), a microphone, a barometer, a temperature sensor, or a gyroscope) and/or the vehicle. RTT computing device 102 and app 118 may be provided by the same insurance provider, as described herein.

In the exemplary embodiment, user computing device 110 of user 104 may generate telematics data 120 when user 104 is driving a vehicle (not shown in FIG. 1). Telematics data 120 may include, without limitation, speed data 122 relating to a speed of the vehicle, turn data 124 relating to turns executed during driving of the vehicle (e.g., such as cornering data), location data 126 relating to a location of the vehicle, (e.g., such as location data from a GPS of user computing device 110 and/or a native GPS of the vehicle), acceleration data 128 relating to acceleration of the vehicle (which may likewise include deceleration data), and braking data 130 relating to braking of the vehicle. Information derived by model 116 from speed data 122, turn data 124, location data 126, acceleration data 128, and braking data 130 may be presented for display to user 104 on a display 132 of a display system of the vehicle via a GUI 134 configured to be displayed on display 132. In some embodiments, the vehicle itself may also generate telematics data that may be transmitted to user computing device 110 and/or RTT computing device 102 for processing and analysis.

In the exemplary embodiment, display 132 may be part of an in-vehicle (e.g., in-dash) entertainment system, also known as an infotainment system, or more generally referred to herein as a display system. GUI 134 may be configured to display visual indicators and other visual graphics relating to operation of the vehicle, telematics data 120, weather data 136, and/or road data 138. The visual indicators and/or graphics may include, for example, a depiction of the vehicle overlaid on a map, a navigation arrow depicting vehicle orientation and/or driving route, text, markers designating road features and/or driving conditions, and/or other visual indicators (e.g., glowing/highlights around certain symbols to trigger viewers' attention), to provide notice to user 104 (or a passenger of the vehicle) of a plurality of operational and/or environmental parameters relating to the vehicle and the surrounding environment. Additionally, selectable icons and/or other selectable elements may be utilized to allow user 104 to interact with GUI 134 and gain access additional information. Text provided as part of GUI 134 may display vehicle speed, traffic alerts, and/or other information, and may include generative text outputs from model 116. The text and visual icons/symbols of GUI 134 may be accompanied by corresponding sound and/or animations to provide additional notice to an operator of the vehicle. For example, the color of the text showing the speed of the vehicle may include a graphic feature that causes the text to display in black if the speed of the vehicle is at or below the posted speed limit but to display in red if the vehicle speed exceeds the posted speed limit. As another example, a change in road and/or travel conditions (e.g., traffic congestion, slick surfaces, etc.) may be accompanied by one or more audible alerts such as a chime sound. Any combination of visual and/or audible cues and/or alerts may be utilized in conjunction with GUI 134 to provide further information and/or assistance to a driver of the vehicle.

In the exemplary embodiment, display 132 may be an in-dash display provided within or in the vicinity of a dashboard of the vehicle, positioned for easy viewing and interaction by the driver and/or passengers. User computing device 110 may be a mobile phone running an operating system including a capability to output content from user computing device 110 for use in a vehicle setting via display 132. In some embodiments, a mirrored GUI of user computing device 110 may be a vehicle-optimized version of a GUI of user computing device 110, including larger than normal icons and text for easy readability and interaction in a vehicle setting. App icons may be provided in a larger size for easier visibility and/or selection in a vehicle setting, for example in the case where display 132 is a touchscreen display. User computing device 110 may be connected with the vehicle's electronics control system for integrating with display 132 via a wired and/or wireless connection, such as a USB connection via a USB cable and/or Bluetooth or WiFi. User computing device 110 may be operatively connected to the vehicle entertainment system via any combination of wired/wireless protocols.

Once connected, GUI 134 may effectively replace a factory/native/stock UI associated with display 132 of the vehicle, such as via screen-mirroring/screen-casting. GUI 134 may be configured to be controlled by controls of the vehicle, such as via a controller interface that may include physical controls (e.g., steering wheel buttons, console control knob, etc.) and/or voice commands received via a microphone of the vehicle and/or of user computing device 110, for user interaction. Voice control may include users 104 dictating commands and/or asking for directions without taking their hands off the steering wheel of the vehicle. Received voice commands may be processed by user computing device 110, by associated electronics of the vehicle and provide for hands-free operation, and/or by model 116. The mirrored GUI may include so-called “core” applications that may be formatted for in-vehicle usage, and may include a navigation app, a music app, a messages app, and a calls app, in addition to app 118.

Display 132 may include a touchscreen configured to controlled by touch controls by user 104 that may include taps, swipes, and/or other interactions with display 132 (direct (e.g., physical) or indirect, such as recognized gestures made by touching the screen or in the air and recognized by a camera that may be integrated or associated with display 132). Additionally, physical controls located on the steering wheel or center console of the vehicle may provide alternative ways to navigate GUI 134. When the vehicle is in motion, certain functionalities may be restricted to prevent driver distraction. For example, not all apps stored on user computing device 110 may be mirrored for use via GUI 134. Users 104 or app providers may set permissions and/or preferences defining what data and/or apps are able to be shared, as well as other settings relating to volume, screen resolution, etc. User computing device 110, the electronics control system of the vehicle, display 132, and/or GUI 134 may include additional, less, or alternate functionality, including that discussed elsewhere herein.

In the exemplary embodiment, external data may include but is not limited to weather data 136 and road data 138. Weather data 136 may include data regarding expected and/or actual precipitation such as rain and/or snow and associated driving conditions, such as live conditions including slippery roads. Road data 138 may include data regarding intersections (such as intersections that have been shown to have a higher rate of traffic accidents), construction and any associated lane closures or detours, railroad crossings, traffic accidents, overall traffic conditions (e.g., congestion, backups, etc.), etc. Weather data 136 may be provided by separate weather service providers and received by one or both RTT computing device 102 and/or user computing device 110. Road data 138 may be provided by separate road service providers such as data from local municipalities and/or may be based upon information learned about a particular street, road, highway, etc. over a period of time and/or from analyzing historical data relating to the particular street, road, highway, etc. Road data 138 may be received by one or both RTT computing device 102 and user computing device 110. While a primary task of RTT computing device 102 is the processing telematics data such as speed data 122, turn data 124, location data 126, acceleration data 128, and braking data 130. RTT computing device 102 may also be programmed to process weather data 136 and road data 138.

In the exemplary embodiment, system 100, including RTT computing device 102, may be configured to leverage edge computing resources in association with an edge computing system including a plurality of edge computing devices. Edge computing system 140 may be an edge computing network operatively connected to network 114 and/or to another network associated with network 114, and may include a plurality of edge computing devices that may include smart infrastructure devices 142 (e.g., smart street/road lights and smart traffic lights), smart vehicles 144, and/or other smart electronics devices 146 (e.g., smart phones, smart wearables, etc.) of nearby people, such as nearby drivers in other vehicles. Smart infrastructure devices 142, smart vehicles 144, and smart electronics devices 146 may collectively be referred to herein as “edge computing devices,” although edge computing devices as described herein are not limited to devices 142-146. For example, the vehicle of user 104 can itself be an edge computing device, and may be configured with the necessary components to connect to network 114 and/or to other devices that can serve as a proxy/passthrough for the vehicle to function as an edge computing device, such as by sharing a hot spot data connection provided by user computing device 110. For example, the vehicle may include wireless communication adapters, storage for data, etc. Similarly, user computing device 110 may be configured as an edge computing device.

A smart vehicle 144 may be completely autonomous (e.g., fully autonomous), semi-autonomous (e.g., partially autonomous), or with any level of autonomy. For example, smart vehicle 144 may operate under various levels of autonomy, including but not limited to Level 5 autonomy (e.g., full driving automation), Level 4 autonomy (e.g., high driving automation), Level 3 autonomy (e.g., conditional driving automation), Level 2 autonomy (e.g., partial driving automation), Level 1 autonomy (e.g., driver assistance), or Level 0 autonomy (e.g., no automation). As used herein the term “autonomous” includes fully autonomous, semi-autonomous, or having any level of autonomy.

Edge computing devices such as devices 142, 144, and 146 may be equipped with sensors, cameras, and/or communication technologies to monitor various environmental factors like air quality, traffic, and weather, and process, receive, and/or transmit corresponding data and/or reports regarding such, in real-time. Edge computing devices such as devices 142, 144, and 146 may be located in a local vicinity of the vehicle, and information obtained by edge computing devices 142, 144, and 146 may be utilized to process and transmit real-time data and may learn their own data trends over time for sharing with RTT computing device 102 in connection with model 116. Each edge computing device such as each of devices 142, 144, and 146 may serve/function as a node of a network such as network 114 and/or other related networks and be configured to receive data, collect data, process data, and/or transmit data, in real-time, in connection with nearby vehicles and, more generally, nearby traffic. Accordingly, edge computing devices such as devices 142, 144, and 146 in many ways may be configured to function in a substantially identical manner as RTT computing device 102, such as with respect to processing telematics data 120 and running model 116 against new data. For example, while edge computing system 140 and/or edge computing devices such as devices 142, 144, and 146 may not be relied upon for training/re-training model 116 in the same manner as RTT computing device 102 is, edge computing system 140 and/or edge computing devices such as devices 142, 144, and 146 may nevertheless be configured to perform local processing of live data such as telematics data 120 at the edge of network 114, thereby reaping benefits such as reduced latency, in particular for embodiments in which a cloud-based version of model 116 is accessible by the edge computing devices. As such, unless otherwise set forth herein, edge computing system 140 and/or edge computing devices such as devices 142, 144, and 146 may be implemented and utilized for performing a significant portion of the data processing and predictive and/or generative tasks described herein, such as during a live driving session. Any plurality and/or variety of edge computing devices may be implemented as part of system 100. For example, user computing device 110 may itself be an edge computing device, as well as mobile phones of other passengers in the vehicle, the same as or similar to edge computing devices 146. In some embodiments, smart infrastructure devices 142 may further include smart roads, etc., and be configured to process a variety of different data, run a plurality of calculations, and execute model 116 against live data such as live telematics data 120. In some embodiments, edge computing system 140 may include logic to determine which edge computing devices are available and use a designated edge computing device. Such determinations by edge computing system 140 may be based upon comparisons of available bandwidth and/or available processing power amongst the various edge computing devices. An optimum edge computing device may be able to be determined by RTT computing device 102 and/or any one edge computing device, so that processing tasks may be delegated to the best-suited device. For example, one edge computing device may pass off tasks to another edge computing device if a determination is made that another device would be the optimum device at a given moment in time or based upon predictions of anticipated workload. Other devices within system 100 may also be configured to assist with determining the most suitable edge computing device to use for a given scenario.

In some embodiments, model 116 may be provided and/or accessible in a cloud-based AI configuration where model 116, including any tools, applications, infrastructure, and/or resources relating thereto, may be hosted on cloud platforms. Model 116 and its related tools, applications, infrastructure, and/or resources may (i) be provided in a cloud network that edge computing system 140 and/or edge computing devices such as devices 142-146 communicate with, (ii) be provided at the edge by computing system 140 and/or edge computing devices such as devices 142-146 tasked with processing telematics data 120 at the edge, or (iii) some combination thereof. These types of configurations may provide on-demand access to model 116 for use with the edge computing aspects described herein. By leveraging a cloud-based AI configurations with edge computing, model 116 may be able to be implemented at the edge of the network to provide the various real-time functionalities described herein.

In some embodiments, edge computing system 140 and/or edge computing devices such as devices 142, 144, and 146 may only need to communicate with RTT computing device 102 in limited circumstances during the course of a live driving session. For example, one or more of edge computing devices such as devices 142, 144, and 146 may send a request to RTT computing device 102 for permission to access model 116 at the beginning of a live driving session. Such a permission may be granted for a defined but limited period of time, so that edge computing devices such as devices 142, 144, and 146 do not have to constantly send requests to RTT computing device 102, which may cause inefficiencies such as increased delays. The permissions granted by RTT computing device 102 to edge computing devices such as devices 142, 144, and 146 may include the ability to access model 116 and/or other permissions such as permitting edge computing devices 142, 144, and 146 to perform periodic “data dumps” from edge computing devices 142, 144, and 146 to RTT computing device 102 or related servers/databases 106 and/or 108, so that RTT computing device 102 receives the fresh data acquired from edge computing devices 142, 144, and 146 from any recent driving trips. In embodiments where model 116 may be accessible in a cloud-based AI configuration, the permissions may include granting cloud access to model 116 so that model 116 may be executed at the edge of the network on live telematics data by edge computing devices 142, 144, and 146.

Smart infrastructure devices 142 may include devices that may be owned/operated/provided by a municipality and/or other entities such as utility companies, which may include power companies, telecommunication companies, etc., and may include devices such as smart street/traffic lights, smart roads, etc. Smart vehicles 144 may include private vehicles of individuals, vehicle fleets owned by various commercial entities such as package delivery companies, municipal vehicles such as public buses and police cars, and/or taxis and ride-share vehicles. Smart devices 146 may be smart phones and smart wearables of individuals. In some embodiments, smart devices 146 may have been opted into being part of a community network service that pools together a small portion of bandwidth from participating devices to create a low-bandwidth, long-range network that can connect devices. Data obtained from edge computing devices 142, 144, and 146 may be utilized to determine real-time traffic conditions, and/or analyzed over time to learn additional aspects such as troublesome intersections where more accidents tend to occur, and other nuanced traffic patterns.

In the exemplary embodiment, a vehicle in which user 104 is driving may, via user computing device 110, leverage the network connection and/or computing resources of edge computing system 140 to assist with providing up-to-date data for app 118 for display on display 132. In one example use scenario, a vehicle of user 104 may be traveling through a city. As the vehicle passes by a smart infrastructure device 142 such as a smart street light or smart traffic light, user computing device 110 and/or the vehicle of user 104 may utilize a data network associated with the smart street light instead of pinging a cellular service tower that may be farther away, especially in view of any disruptions in service experienced in cities due to tall buildings that may reduce cellular signal strength. Real-time scores and/or other outputs from model 116 may be provided via the local/edge-configured smart street light instead of from a faraway device.

By using the local edge network provided by edge computing system 140, reduced latency in data transmissions may be realized so that app 118 is able to display real-time data such as real-time weather, scores, and the like, to user 104. Edge computing system 140 may provide consistent and persistent connectivity and may process data closer to the source (e.g., in the vehicle itself or at nearby edge devices), reducing the need to send all data to distant cloud servers, thereby minimizing latency. Edge computing system 140 and devices thereof may be part of a decentralized architecture configuration, where distributing processing tasks across multiple edge devices enhances the robustness and reliability of RTT computing device 102. Other benefits may include load balancing, where edge computing can balance data processing loads, ensuring that no single device or network segment is overwhelmed, improving overall efficiency.

Expanding on the above use scenario, as user 104 drives their vehicle in a city, the vehicle of user 104 may be operatively coupled with user computing device 110 so that GUI 134 is displayed on display 132. As the vehicle of user 104 approaches an intersection, user computing device 110 may communicate with a smart infrastructure device 142 such as a smart traffic light. Due to low latency provided by the edge computing connection of smart infrastructure device 142, user computing device 110 may receive near instant updates on traffic jams, and suggested driving behaviors, etc., optimizing a driving route and driving style for the given situation. Additionally, using the same edge computing connection provided by smart infrastructure device 142, app 118 may display an output from model 116 that relates to a real-time maneuver of the vehicle. For example, model 116 may, based upon sensor data received as part of telematics data 120 from user computing device 110, and by utilizing edge computing resources such as provided by smart infrastructure device 142, generate a real-time determination relating to the operation of the vehicle by user 104. The real-time determination may include GUI 134 displaying a warning to user 104 that the vehicle turn that was just executed was made at an unsafe speed and/or at an unsafe angle, thereby providing real-time driving suggestions for user 104. In such a case, GUI 134 may display a visual prompt that it would be safer to take turns at 5 mph than at 12 mph. Driving events such as the speed at which a turn is made may also be correlated to a so-called “safe driving score” in conjunction with a scoring system associated with an insurance provider of user 104. Scenarios such as these may also result in the activation of certain autonomous driving features as described herein.

In the exemplary embodiment, models 116 may be trained to alert a user 104 of real-time driving events to help facilitate safer driving, such as if the user, when driving a vehicle, is accelerating too quickly, driving too fast, braking too harshly, or turning too aggressively the system can recommend safer driving behaviors. Models 116 may be trained to predict driving styles, behaviors, and reactions of an individual user 104 based upon driving data collected by app 118. For example, RTT computing device 102 may be in operative communication with app 118, such that RTT computing device 102 retrieves or otherwise receives (e.g., via edge computing system 140) user data from user computing device 110. RTT computing device 102 may retrieve/receive user data periodically and/or continuously, for example continuously during a driving session. In some embodiments, RTT computing device 102, based upon data received from user computing device 110, may be programmed to detect and determine a vehicle in which user 104 is present and/or operating, such as in the case where user 104 may not be driving their normal vehicle. This detection or determination may be based upon acceleration data, map data, and/or other data indicative of the vehicle being in a live driving session. The systems and devices shown in FIG. 1 may include additional, less, or alternate functionality, including that discussed elsewhere herein.

### Exemplary Computing Components And Network

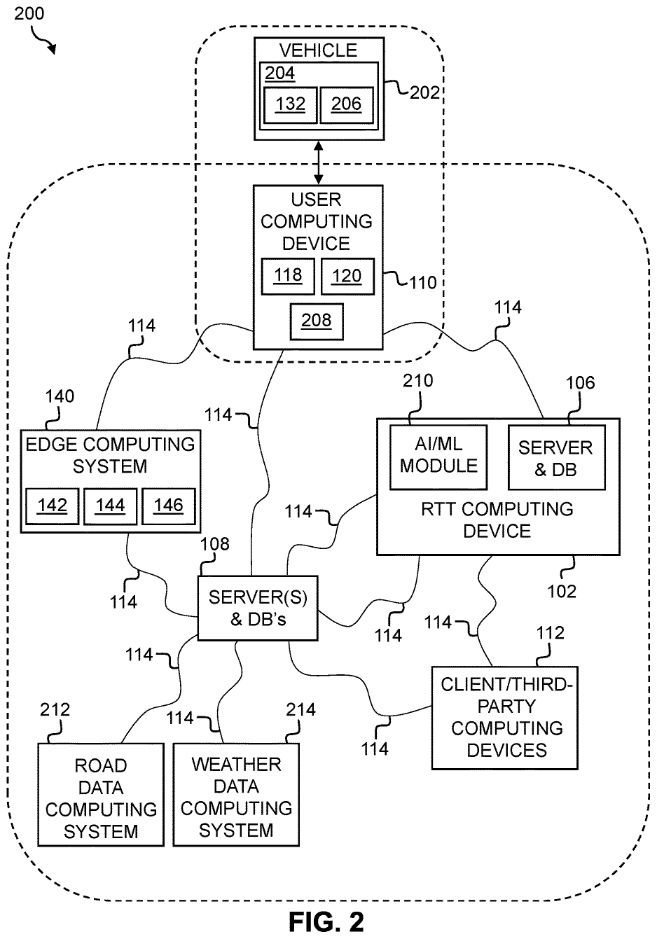

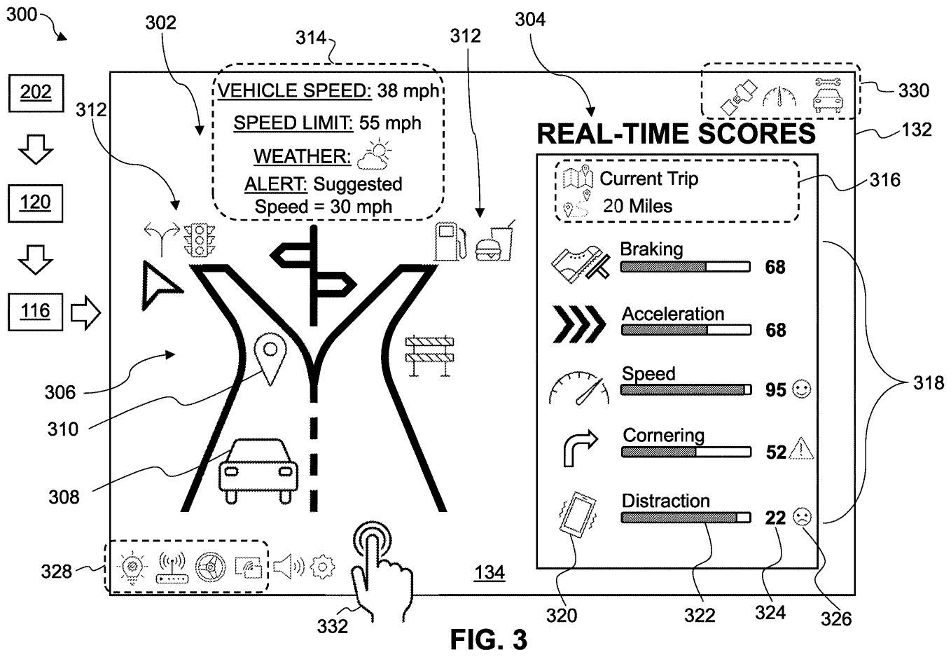

FIG. 2 illustrates a block diagram 200 of computing and network components of system 100 shown in FIG. 1. In the exemplary embodiment, a vehicle 202 may include a vehicle computing system 204 that may include an electronic and/or computer control device (not shown), a display 132, and/or a plurality of sensors 206 that may include but is not limited to cameras, pressure sensors, speed sensors, temperature sensors, a GPS, and the like, or as otherwise described herein. Vehicle computing system 204 may further include components capable of operatively connecting and/or communicating with user computing device 110, for example via wired and/or wireless communication connections (e.g., USB, Bluetooth) that may enable an operating system and/or user interface of user computing device 110 to be displayed on display 132, as described herein. Additionally, vehicle computing system 204 of vehicle 202 may include components configured such that vehicle 202 itself can be an edge computing device, as described herein, such as by way of wireless adapters present within vehicle computing system 204. User computing device 110 may include app 118 stored thereon and/or executable therefrom and a plurality of sensors 208 which may include but are not limited to an accelerometer, a GPS, a microphone, a barometer, a temperature sensor, and/or a gyroscope, or as otherwise described herein. In some embodiments, vehicle 202 may be a smart vehicle the same as or similar to smart vehicles 144 and user computing device 110 may be the same as or similar to smart devices 146, each shown in FIG. 3, and configured for edge computing tasks.

User computing device 110 may generate telematics data 120 based upon outputs from sensors 206 as vehicle 202 is being driven and transmit telematics data 120 to RTT computing device 102 and/or edge computing devices via network 114, which may include the usage of edge computing system 140 to facilitate edge computing aspects. Edge computing devices 142, 144, and 146 may be located in a local vicinity of vehicle 202. For example, computing devices (e.g., devices 102, 110, 142, 144, 146) associated with network 114 may be configured to determine which node (e.g., which device of edge computing devices 142, 144, 146) of edge computing system 140 would be best-suited to utilize for local processing and/or transmission of data. A determination of the optimum edge computing device may be based upon factors such as network traffic, bandwidth, reliability, security, efficiency, distance, processing power/speed, delay/latency, and the like, and performed to select an optimum device for purposes of data processing, transmission, etc., and may include the passing off of tasks from one edge computing device to another if the other device is determined by edge computing system 140 to be the optimum device. RTT computing device 102 and/or edge computing devices may process the received telematics data 120 via model 116 as described herein. One or more results of outputs from RTT computing device 102 and/or edge computing devices may be provided via network 114 (which may include data transmission via edge computing system 140) to app 118 for display via GUI 134 to user 104. Each of vehicle 202 and user computing device 110 may also include one or more output devices (not shown) such as speakers and/or other gauges and/or display/notification components to provide information to users 104.

RTT computing device 102 may include server/database 106 and an AI/ML module 210 configured for the training, re-training, deployment, and/or other management/monitoring of one or more models 116. AI/ML module 210 may be the primary component of RTT computing device 102 designated for performing tasks related to model 116, although other processors and/or software modules may be utilized in conjunction with AI/ML module 210. AI/ML module 210 may also be programmed for ancillary/related downstream tasks such as formatting outputs from model(s) 116 for use by user computing device 110. AI/ML module 210 may be a software module that utilizes local dedicated hardware within or associated with RTT computing device 102 to perform AI/ML-related tasks. The dedicated hardware may be a processor specifically configured for intensive, dedicated AI/ML processing tasks, such as one or more dedicated GPUs. While not shown, edge computing system 140 and/or edge computing devices such as devices 142-146 may also include a module the same as or similar to AI/ML module 210 so that live telematics data 120 may be processed at the edge of the network.

In some embodiments server/database 106 may be remote from RTT computing device 102. Server/database 106 may be cloud-based. Network 114 may be implemented to provide operative communication, direct or indirect, between RTT computing device 102, server/database 106, one or more servers/databases 108, user computing device 110, third-party computing devices 112, edge computing system 140, a road data computing system 212 associated with providing reports such as traffic reports, and a weather data computing system 214 associated with providing weather reports. In some embodiments, certain servers/databases of servers/databases 108 may be integrated with the various devices 112, 142, 144, 146, devices of system 212, and/or devices of system 214. In some embodiments, network 114 may be a plurality of interoperable networks, including the internet, cellular, satellite, and the like, as well as NFC and the like, and as described herein. The devices shown in FIG. 2 may include additional, less, or alternate functionality, including that discussed elsewhere herein.

### Exemplary User Interface

FIG. 3 illustrates a diagram 300 of an exemplary GUI used within system 100. As vehicle 202 is being driven, sensors 208 of user computing device 110 may generate outputs to be collected and used for generating telematics data 120. Telematics data 120 may be input into model(s) 116 for processing by model(s) 116, and one or more corresponding outputs from model(s) 116 may be transmitted (e.g., from RTT computing device 102 and/or edge computing devices, via network 114) to user computing device 110 so that app 118 may process the outputs from model(s) 116 for display in a user-readable format as part of GUI 134 on display 132. GUI 134 may display a plurality of visual information as described herein, and may include a map interface 302 and a score interface 304. In the exemplary embodiment, GUI 134 may display map interface 302 on one portion (e.g., a left portion) of display 132 and score interface 304 on an opposite (e.g., right) portion of display 132, although other arrangements of interfaces 302 and 304 are envisioned, such as map interface 302 being displayed at a top portion of display 132 and score interface 304 being displayed on a bottom portion of display 132. Vehicle 202 may also include a plurality of other software and/or hardware components (not shown), which may include dedicated controllers and the like.

GUI 134, via at least interfaces 302 and 304, provides a user 104 with real-time visual feedback during their live driving route, where the real-time visual feedback may include a map, real-time driving behavior scores, speed limits, ambient speed of surrounding traffic, etc. Moreover, GUI 134 may display to a user 104 visual informational of predictive and/or generative outputs from model 116. For example, GUI 134 may display the results of predictive modeling and previous driving, vehicle, and/or external data to alert user 104 when they are accelerating too quickly, driving too fast, braking too harshly, and/or turning too aggressively. GUI 134 may provide an overlay of a driving trip route with visual display elements and/or other visual/audible cues that may include color coding and/or icons to identify dangerous behavior and low scores versus safe behavior and high scores and/or certain designated sounds. Scoring may be performed in a manner that is specific to certain vehicle makes and models and a particular user's driving history. System 100 may also use data from user computing device 110 to identify a user 104 and use their individual driving history and driving styles to enhance a real-time score to anticipate potential driving conditions and provide alerts to user 104, personalized for their particular situation.

Map interface 302 may include a plurality of visual display elements that may include a digital map 306 such as a live, GPS-driven map. Map 306 may include a navigational arrow corresponding to GPS-based directional guidance, and map 306 may also be overlaid or otherwise provided with a variety of other display elements. These other display elements may include a visual representation 308 of vehicle 202 on map 306, markers 310 marking destinations and/or other points of interest on map 306, and symbols 312 designating various aspects such as upcoming intersections and/or traffic lights, construction and/or lane closures, fueling stations, restaurants, etc. Map interface 302 may also include informational elements 314 which may include but are not limited to operational and environmental information such as a current speed of vehicle 202, speed limits of the section of road on which vehicle 202 is driving, weather information of the surrounding geographical area, and other miscellaneous information such as local alerts, which may include local traffic alerts, etc. Additional information may be sourced from sources such as weather data 136 and road data 138, without limitation. Map interface 302 may include additional, less, or alternate functionality, including that discussed elsewhere herein.

Score interface 304 may include various display elements which may include a travel indicator 316 that may include current trip and mileage information. For example, travel indicator 316 may automatically, or as set by user 104, start logging a new trip and/or mileage data at a certain point in time, such as when the vehicle is started, and may include additional functionality such as storing individual and/or cumulative trip/mileage counts over time. Score interface 304 may include category display elements 318 associated with various driving data categories that may be included within telematics data 120, including speed data 122, turn data 124, acceleration data 128, and braking data 130. Score interface 304 may also include additional categories that may be displayed as part of category display elements 318, such as a “distraction” category relating to distracted driving, which may be based upon a determination that user 104 is using their user computing device 110 while driving. For example, distracted driving based upon usage of user computing device 110 while driving may be able to be determined by a gyroscope output from user computing device 110.

Category display elements 318 may include a plurality of visual display elements that may include easy to read/understand symbols, progress bars, numeric scores associated with the respective scoring categories, and/or other symbols to convey to a user whether or not their driving data is within a defined safety range. In the exemplary embodiment, each category of category display elements 318 may include a category symbol 320 corresponding to and designating a particular category, a score bar 322 which may provide a visual indication of scoring for a particular category relative to a top score (e.g., 100) of a scoring scale, a raw numerical score 324 that may correlate to score bar 322 and the scoring scale, and/or a rating symbol 326 that may indicate whether a given score is deemed unsatisfactory, satisfactory, and/or above satisfactory with respect to a designated score.

In the exemplary embodiment, categories of category display elements 318 may include braking, acceleration, speed, cornering, and one or more other categories relating to additional information such as distracted driving. For example, category symbol 320 for the braking category may include a visual icon representing a foot and a brake pedal and an associated text description of “Braking.” Score bar 322 may represent a total scoring range, for example from 0 to 100. A score may be represented via score bar 322 in a manner such as shown in FIG. 3, using different coloration in the score bar to set apart the achieved score relative to the top score. For example, for a score bar 322 illustrating a score of 50/100, half of the bar would be one color and the other half a different color. Numerical scores 324 may display a numerical representation of the current score of a driver (e.g., user 104). Compared to score bar 322, numerical score 324 may only show a standalone score absent a corresponding upper or lower end of a score range (e.g., 0 to 100). Rating symbol 326 may be used as an additional visual display to apprise a driver of if their driving behavior for any given category is, in simple terms, good, needs improvement, or merely average/acceptable. In some embodiments, rating symbol 326 may display a positive symbol such as a smiley face when the driver has a score above a certain threshold amount. Similarly, rating symbol 326 may display a negative symbol such as a frowning face when the driver has a score below a certain threshold amount. Additionally, rating symbol 326 may display a warning symbol, such as an exclamation point, when a driver has a score that is close to an undesired threshold amount. Certain scores may not trigger any rating symbol 326 to display.

For example, as shown in FIG. 3, for a score scale of 0 to 100, a score of 95 may cause a smiley face to be generated and displayed next to the corresponding score 324. A score of 22 in a given category may cause a frowning face to be generated and displayed next to the corresponding score 324, indicating that a score of 22 is well below a desired or designated score. A score of 52 in a given category may cause a warning symbol such as an exclamation point to be generated and displayed next to the corresponding score 324, to serve as an indication to the driver that the score of 52 is undesirable. A score of 68 in a given category may cause no rating symbol 326 to be generated or displayed, indicating that a score of 68 resides in a satisfactory range on the overall scoring scale.

The scoring scale may be determined and set in conjunction with a set of rules and/or a scoring rubric used by model(s) 116 such that the numerical value of numerical scores 324 correlate to a pre-determined safe driving score. In addition to score bar 322 and numerical scores 324, rating symbols 326 may help persuade or motivate a driver to change their driving behavior. For example, for a score scale ranging from 0 to 100, any score of 50 or below may correspond to unsafe driving behavior in correlation with safe driving determinations made by model 116, and may trigger a negative rating symbol 326 to be displayed. A score greater than 50 but below 60 may correspond to risky driving that is close to being in the unsafe driving score range, as determined by model 116, and may trigger a warning rating symbol 326 to be displayed. A score greater than 60 but below 80 may correspond to adequate/acceptable driving based upon determinations made by model 116 and may not cause any rating symbol 326 to be displayed. A score greater than 80 may correspond to excellent driving based upon determinations made by model 116 and may cause a positive rating symbol 326 to be displayed. Score interface 304 may include additional, less, or alternate functionality, including that discussed elsewhere herein.

While not shown in FIG. 3, model 116 may also generate a composite score based upon averaging or otherwise taking into account each individual score such as for each category of braking, acceleration, speed, cornering, and distraction. The composite score may be shared with user 104 upon conclusion of a certain amount of trips or on a periodic basis, such as once a month. The composite score may be derived contextually. For example, model 116 may afford certain individual scores different weight depending on the driving circumstances in which the scores were generated. In one example, model 116 may know that user 104 obtained a score of 60 during a given trip for the speed category. However, model 116 may also know that traffic on that particular trip was very light, and travel was done primarily via the interstate, and as such there was less risk than in other scenarios that excessive speeding would dramatically increase a likelihood of an accident. Model 116 may take such contextual analysis into account when generating a composite score. Composite scores may be tallied for a designated duration of time (e.g., six months, one year, etc.) and used by an insurance provider to adjust rates and/or offer incentives to insurance customers depending on the “final” composite score. By doing so, users may be motivated to strive for high scores, and thus exhibit safe driving behaviors.

GUI 134 may also include (i) status symbols 328 associated with various features to indicate an operational status of the various features. These features may include screen mirroring, autonomous features, edge computing features, and generative AI features, and the appearance of the status symbol for each may serve to indicate that the features are activated/engaged, and (ii) vehicle health and safety symbols 330 associated with user notifications relating to vehicle safety and/or maintenance aspects. For example, as shown in FIG. 3, status symbols 328 may include, without limitation, a wireless display symbol for indicating screen mirroring being active, a steering wheel symbol for indicating autonomous features being active, a wireless computing symbol indicating that the edge computing features are active, and a light bulb/gear symbol indicating generative AI features are active. Symbols 328, when clicked, may provide user 104 with the option to change or disable the corresponding feature. Vehicle health and safety symbols 330 may include symbols corresponding to the need to fasten an unbuckled safety belt, an oil change status, proper tire air pressure, and/or other maintenance. In some embodiments, GUI 134 may display vehicle health and safety symbols 330 based upon information and/or data derived or received from onboard diagnostic outputs of vehicle 202, in addition to any corresponding information derived from user computing device 110. In the exemplary embodiment, user 104 interacts with GUI 134 via touch control 332, although in some embodiments control via physical controls (e.g., buttons, knobs) of vehicle 202, such as via steering wheel control buttons, and/or control via user computing device 110 (e.g., when user computing device 110 is paired with vehicle computing system 204, such as via Bluetooth) is encompassed within the types of user control of GUI 134. GUI 134 may include additional, less, or alternate functionality, including that discussed elsewhere herein.

### Exemplary Model Training, Deployment, and Use

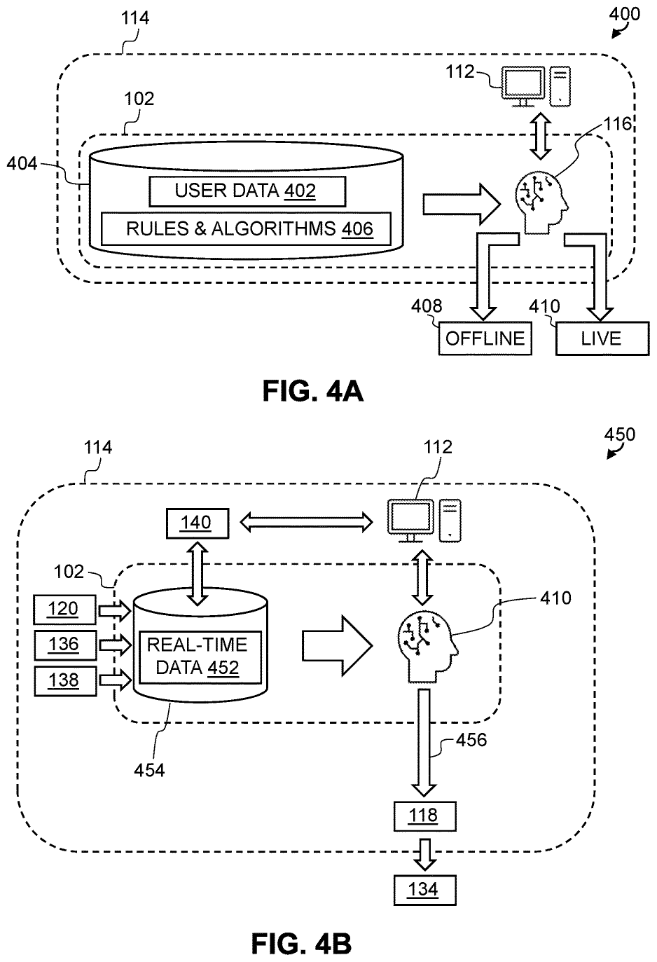

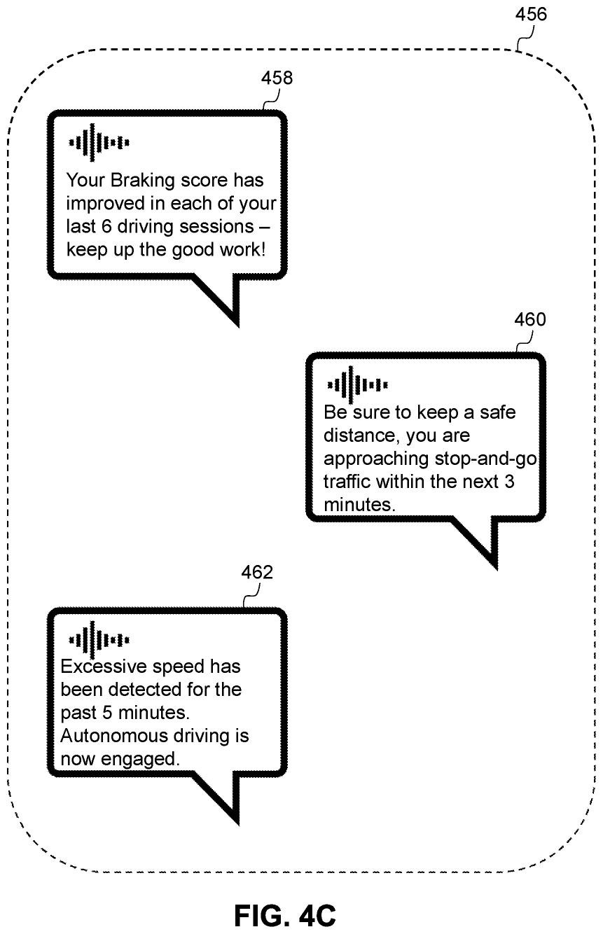

FIG. 4A illustrates a diagram 400 of an exemplary model built for and used in conjunction with system 100. In the exemplary embodiment, AI/ML techniques may be used to leverage driving data and other data of a plurality of users 104, which may include millions of previous trips and driving sessions. Various user, vehicle, claims, and/or external data may be combined for use in predictive modeling.

In the exemplary embodiment, RTT computing device 102 may retrieve/receive user data 402. User data 402 may include both historical user data and/or individualized user data that may include candidate user data retrieved from a user data database 404 that may be stored in a memory of or associated with RTT computing device 102, such as in one or more of servers/databases 106 and/or 108. User data database 404 may store user data 402 which may include but is not limited to (a) personal data (e.g., demographics data), (b) previous driving, vehicle, and/or external data, which may include (i) sensor data (e.g., generated by sensors that may be included within or be in communication with user computing devices 110, and used in connection with telematics data 120), (ii) location data (e.g., from a GPS sensor and/or other location sensors that may be included within or be in communication with user computing devices 110 and/or vehicles 202, and used in connection with location data 126), and/or (iii) external data (e.g., third-party data, which may include weather data 136 from weather data services and road data 138 from corresponding data sources such as publicly available traffic reports and accident reports), (c) usage data from user computing devices 110 such as mobile phone usage, and/or (d) insurance data (e.g., associated with insurance policies held by users 104 and associated premiums of the insurance policies and any insurance claim data).

User data database 404 may also store a plurality of rules and/or algorithms 406 used for the grading/scoring of driving behaviors to determine safe driving scores and used in conjunction with the training and validation of model 116, as well as for generating other predictive and/or generative outputs via model 116 based upon the processing of user data 402. Alternatively, rules and algorithms 406 may be stored in a separate database that is in operative communication with user data database 404. RTT computing device 102 may utilize rules and algorithms 406 in conjunction with AI/ML techniques to build model(s) and then analyze the data via one or more built models 116. For example, RTT computing device 102 may utilize supervised, semi-supervised, and/or unsupervised ML techniques to analyze the user data.

When deemed necessary, such as by a provider of system 100, model(s) 116 may be updated or re-trained, and one or more new models 116 that has/have been updated or re-trained may be deployed. Model(s) 116 may be updated or re-trained for any variety of reasons. For example, model(s) 116 may be updated to revise various weighting factors, hyperparameters, and/or other aspects of any underlying scoring rules and/or algorithms for improved correlation and accuracy. Model(s) 116 may be re-trained when a certain threshold of new input data and/or new outputs from model(s) 116 have been obtained. Re-training may be performed on an as-needed basis or on a periodic basis (e.g., once every 6 months). In some embodiments, RTT computing device 102 may, via network 114, leverage third-party computing devices 112 that may be arranged in a distributed computing configuration, to take advantage of parallel processing in association with processing intensive tasks such as building and training one or more model(s) 166, and/or operating a live version of model 116 for real-time usage as described herein. Third-party computing devices 112 may in some cases be additional computing devices owned/operated/provided by the same entity associated with RTT computing device 102, and as such may be devices of the same party (e.g., not a third-party).

Once trained, model(s) 116 may use generative AI to help drivers understand, support, and/or protect their vehicle, driving behaviors, and driving environments. RTT computing device 102 may assess, in real-time, the likelihood of potential insurance-related incidents and crashes based upon telematics data that RTT computing device 102 collects, taking into account, in real-time, (i) the type of vehicle, (ii) the type of driver, and (iii) current driving conditions. By comparing current driving data with historical and claims data used to train model 116, RTT computing device 102 may identify unusual or inconsistent trends in the driving trips of vehicle 202 and notify the driver, which may include providing recommendations such as preventative measures and steps to mitigate issues and dangerous situations, and/or assist with insurance-related disputes. For example, system 100 may be able to analyze outputs from an onboard camera and/or computer vision system of the vehicle to determine fault in an accident involving the vehicle, and/or to verify that an insurance customer's explanation of an incident such as an accident is accurate and/or supported by evidence.

In the exemplary embodiment, historical user data may be retrieved by RTT computing device 102. Historical data may result from being collected from users that may opt-in to allow for data to be collected and shared with RTT computing device 102. For example, users may grant an insurance provider data usage permissions and/or agree to terms and conditions associated with RTT computing device 102 relating to retrieving user data from their accounts when the users register for an insurance policy with the insurance provider.

Historical data may include one or more of a historic trip report associated with historic driving trips and/or other historical user and/or external data. The historic trip reports may be generated by the user, and/or recreated based upon information that may include, without limitation, historical GPS and accelerometer information from user computer device 110. Historic driving trip reports may include a distance traveled, an amount of time traveled, time of day of trip, weather conditions, driving behaviors exhibited during the trip, and/or traffic conditions present at the time of the trip. Additionally, historic trip reports may include prior accident data and/or successful trip data. Accident data may include the date and time of the accident, location of the accident, severity, weather conditions present at the time of the accident, personal injury data and/or property damage data.

Accident data may also include a damage amount associated with the cost of the accident. For example, accident data may include a cost associated with medical expenses and/or a cost associated with the repair and/or replacement of property damaged during the accident. In some cases, historic trip reports may include a number of successful trips and a number of trips that resulted in or included an accident. This historical data may be input into one or more models 116 to build and train the models, and to ultimately produces models that generate driving behavior scores and/or other predictive and generative models relating to driving behavior of users.

In some embodiments, models 116 may be based upon data received during a trial period of time and a validation period of time. User 104 may register with system 100 via an enrollment process provided by app 118 and/or other registration process associated with the provider of system 100. During the trial period of time, which may commence after user 104 enrolls with system 100, RTT computing device 102 may retrieve user data to determine a trial driving behavior of user 104. Specifically, RTT computing device 102 may use model 116 to predict the trial driving behavior of user 104 using user data collected during the trial period. Subsequently, during a validation period of time, RTT computing device 102 may retrieve user data to determine a validation driving behavior of user 104. Specifically, RTT computing device 102 may use model 116 to predict the validation driving behavior of user 104 using user data collected during the validation period. During a validation process, RTT computing device 102 may compare the trial driving behavior to the validation driving behavior.

If RTT computing device 102 determines that the validation driving behavior is substantially similar to the trial driving behavior, the validation process may be determined as being successful. If RTT computing device 102 determines that the validation driving behavior is not the same as the trial driving behavior, the validation process fails. If the validation fails, RTT computing device 102 may determine an updated driving behavior using model 116 and user data collected during at least one of the validation period, trial period, and/or a combination thereof. Upon validation failure, RTT computing device 102 may determine an updated driving behavior using the model and the user data collected during at least one of the training period, the validation period, and/or a combination of the user data collected during both the training period and the validation period. In some cases, the validation driving behavior may be substantially different from the trial driving behavior, and in such instances, RTT computing device 102 may determine an updated driving behavior using the model and the user data collected during the validation period. This validation process may be subsequently repeated any number of times in order to maintain or update the most current driving behavior of the user.

After the training period, RTT computing device 102 may continue to retrieve data, periodically or continuously, from the user computer device to track and/or monitor the driving behavior of the user. For example, after the training period, RTT computing device 102 may retrieve data from the user computing device for a validation period of time. During the validation period, RTT computing device 102 may generate a validation driving behavior that reflects the driving/traveling habits of the user during the validation period. RTT computing device 102 may then compare the validation driving behavior to the trial driving behavior, in order to complete a validation process. In some cases, during the validation period, RTT computing device 102 may compare user data collected during the validation period with the user data collected during the training period. Further, in some embodiments, RTT computing device 102 may adjust an insurance policy and/or associated premium based upon the determined driving behavior of the user, such as to reward users for safe driving behavior.

In some embodiments, RTT computing device 102 may analyze, using one or more generated models 116, the historical user data to cluster users based upon certain factors that may, without limitation, include certain factors that have been determined to more closely correlate with aspects of driving behavior, including age, vehicle type, and residence location (e.g., rural, city), and determine the driving trip types most frequently utilized by users of each cluster. Additionally, or alternatively, upon retrieving the historical user data, RTT computing device 102 may generate a model 116 that predicts driving behaviors performed by users based upon the user data. In addition to historical user data from the plurality of users, the modeling computer device may also receive contextual data. The contextual data may include, but is not limited to, street maps, public transportation schedules, rules of travel for various forms of travel (such as sourced from weather data 136 and/or road data 138), and any other information to allow the system to determine how different users may have traveled. RTT computing device 102 may analyze, using one or more generated models 116, the historical user data to cluster users based upon user data that may include demographic data that may include residence location (e.g., by cities, neighborhood, street ranges) and/or age, occupation, education, etc., and determine the driving behavior frequently performed by users of each cluster. RTT computing device 102 may utilize AI/ML techniques to analyze the historical data in view of the contextual data. For example, RTT computing device 102 may utilize supervised, semi-supervised, and/or unsupervised ML techniques to analyze the historical user data and the contextual data to determine the driving behavior of a user is associated with a plurality of trips taken by the user. For example, the driving behavior of a user may include time of travel, time of day of travel, an amount of time spent driving, and distance traveled.

In supervised learning, RTT computing device 102 may use labeled historical user data to determine what driving behavior characteristics are most frequent based upon user data associated with the users. For example, RTT computing device 102 may use labeled historical data to determine which driving behavior characteristics are most common for users in different age ranges (e.g., 16-24, 25-40, 41-60, 61-85, etc.). In unsupervised learning, RTT computing device 102 may use unlabeled historical user data to cluster users based upon the most common modes of transportation used by the users. Once the clusters are generated by RTT computing device 102, RTT computing device 102 may determine the attributes of the users that are similar between the clusters. For example, RTT computing device 102 may determine that a cluster of users under the age of 40 are the most likely to exhibit distracted driving via mobile phone usage while driving a vehicle, while a cluster of users who are over the age of 60 may be more likely to consistently drive at or below a posted speed limit. Semi-supervised learning may be substantially similar to supervised learning, and RTT computing device 102 may use labeled user data to adjust the clusters of users and make sure that the clusters of users are accurate by using the labeled user data as training data.

Once the model is generated by RTT computing device 102, RTT computing device 102 may store one or more models 116 in a database that may be in communication with RTT computing device 102 such as server/database 106. RTT computing device 102 may further train and adjust the model as RTT computing device 102 receives more user data (e.g., historical user data and/or candidate user data). Once the historical user data has been analyzed and RTT computing device 102 has generated the model(s), current user data associated with a candidate user may be input into the model to predict driving behaviors and/or other driver responses in different driving scenarios. The current user data, like the historical user data, may include, for example, personal data, telematics sensor data, location data, insurance data, and/or third-party data, as described herein.

Additionally, or alternatively, once the historical user data has been analyzed and RTT computing device 102 has generated model(s) 116, current user data associated with a candidate user may be input into the model(s) to predict driving behavior of the candidate user, and, in some embodiments, an insurance policy and associated premium for the candidate user based upon predicted user driving behavior. The current user data, like the historical user data, may include, for example, personal data, telematics sensor data, location data, insurance data, and/or third-party data. RTT computing device 102, using the model(s), may determine which cluster the candidate user fits into based upon the current user data to predict the driving behavior performed by the candidate user, and generate an insurance policy and associated premium based upon the cluster of the user.

FIG. 4B illustrates a diagram 450 of an exemplary usage of a model 116 used in conjunction with system 100. In the exemplary embodiment, in real-time, telematics data 120, weather data 136, and/or road data 138 may be obtained and stored as real-time data 452 in a real-time data database 454. Real-time data database 454 may be stored in a memory of or associated with RTT computing device 102, such as in one or more servers/databases 106, and/or servers/databases 108 that may be associated with edge computing system 140 and devices thereof. Alternatively, or additionally, edge computing devices such as devices 142-146 may include an internal dedicated sever/database (not shown). Real-time data 452 may be transmitted to RTT computing device 102 and/or edge computing devices via network 114. For example, in a live driving session, real-time data 452 may be operated on/at via edge computing devices for improved real-time results, whereas after the trip is over the data may be pushed to RTT computing device 102 for subsequent processing/analysis. In some embodiments, real-time data database 454 may be cloud-based for improved operability with cloud-based AI embodiments described herein. User computing device 110 and/or app 118 installed on user computing device 110 may retrieve various information and data as described herein to model a current trip of a user 104. User computing device 110 and/or app 118 may transmit real-time data 452 to RTT computing device 102. In the exemplary embodiment, user computing device 110 and/or app 118 may transmit real-time data 452 continuously to RTT computing device 102. In some embodiments, user computing device 110 may collect real-time data 452 continuously and periodically transmit real-time data 452 to RTT computing device 102 in bulk.

In the exemplary embodiment, RTT computing device 102 may, via network 114, leverage edge computing system 140 and edge computing devices 142, 144, 146, and/or third-party computing devices 112 that may be arranged in a distributed computing configuration, to take advantage of local and/or parallel processing in association with processing intensive tasks such as operating a live version of model 116 for real-time usage as described herein. For example, offline versions 408 of model 116 may be stored and utilized to conduct various offline validation and/or testing while at the same time a finalized live model 410 of model 116 may be deployed and utilized for live usage with real-time data 452. The providing of real-time data 452 to RTT computing device 102 may include transmissions and/or processing tasks that are performed or aided by edge computing system 140, to reap the benefits of edge computing such as reduced latency, etc., as described herein. In some embodiments, edge computing system 140 may be configured to share/offload certain processing tasks with one or more third-party computing devices 112, such as by utilizing distributed computing and parallel processing, as described herein. Live model 410 may process real-time data 452 in association with the extra compute resources of third-party computing devices 112 and/or edge computing system 140. Any number of software/code implements such as routines, sub-routines, interrupts, and the like may be utilized in conjunction with the real-time aspects of system 100 at large, and for individual components of system 100, such as RTT computing device 102. For example, the underlying code used for providing real-time information as described herein may be optimized for performing such real-time tasks, which may include a focus on code that is highly efficient and/or not likely to introduce delay into either the system and/or the various data processing tasks.

Once live model 410 processes real-time data 452, data outputs 456 from live model 410 may be utilized in conjunction with a scoring system as described herein and be transmitted to user computing device 110 so that the generated driving behavior scores for various driving behaviors in real-time may be displayed in the vehicle. Data outputs 456 may also include data corresponding to predictive driving suggestions and/or other generative outputs as described herein and as shown, for example, in FIG. 3. The scores may be displayed as part of a GUI such as GUI 134 to provide drivers with a visual indication of their driving scores, such as shown in FIG. 3 at informational elements 314. However, instead of processing data and generating scoring after a trip is completed, live model 410 is configured to calculate and forecast scores and/or other predicted driving behaviors in real-time by, for example, making estimations in seconds or minutes before a driving action may be taken, such as by leveraging edge computing via edge computing system 140. This marks a notable improvement over conventional lagging indicator-based telematics systems. Additionally, data from mobile phones (e.g., user computing devices 110) may be used to identify drivers and use their driving histories and driving style to enhance real-time scoring and to anticipate potential driving conditions and to provide alerts to drivers in a personalized manner, tailored to their particular situation. In one example scenario, model 116 may have learned over time that a particular driver typically takes turns too hard in rainy weather conditions. Accordingly, in a scenario where live model 410 may determine that rain will be starting within the next 5 minutes and that vehicle 202 will be driving in a location where frequent turns will likely be required, an advance warning and/or suggestion/reminder may be displayed via GUI 134 to inform the driver that rain will be starting soon and to drive carefully and take turns lightly. This is one example of how live model 410 may contextually associate a plurality of data to provide user-and situation-specific generative information that may be of great value and assistance to a use while also increasing the likelihood of safe driving.

As another example of a generative and/or predictive outputs from outputs 456 of live model 410, based upon analysis of real-time data 452 via live model 410, it may be determined that while the posted speed limit on the section of highway that vehicle 202 is travelling is 55 mph, there is a projected slow-down in traffic and the ambient speed of vehicles located ahead is 30 mph (e.g., where ambient speed may be determined from road data 138). Thus, while 55 mph would be a safe speed under normal circumstances, under current conditions a speed of 55 mph would be unsafe given that surrounding vehicles are only averaging 30 mph speed. With reference to FIG. 3, based upon a determination made by live model 410, RTT computing device 102 may issue an instruction to app 118 to update informational elements 314 to display a “Suggested Speed” alert. In this scenario, while the posted speed limit is 55 mph and vehicle 202 is driving at 38 mph (e.g., in compliance with the posted speed limit), the suggested driving speed, based upon the determined speed of surrounding traffic, is 30 mph. Live model 410 may output generative data such as the “Suggested Speed” alert that includes contextual analysis of a given driving behavior (e.g., speed) relative to current driving conditions (e.g., congested traffic), thereby providing context for the user between a status of a driving behavior and current driving conditions (as well as other present conditions). Alerts such as included with informational elements 314 may also include simpler alerts, such as simply “SLOW DOWN” and the like. These alerts may be generated using natural language processing via model 116 and may take the form of any form of statement and language implement to convey the necessary meaning/intent for understanding by the driver.

By using historical and real-time data, system 100 may function as a “smart” system that uses predictive and/or generative AI to help drivers understand, support, and protect their vehicle, driving behavior, and driving environments. System 100 may be configured to assess, in real-time, the likelihood of potential insurance-related incidents such as crashes, based, for example, upon telematics data that is collected, while taking into account, in real-time, and without limitation: (1) the type of vehicle; (2) the type of driver; and/or (3) current conditions (e.g., weather and/or traffic conditions). By comparing current data with historical and/or claims data, system 100 may identify unusual and/or inconsistent trends in vehicle operation and/or driving trips and notify the driver, providing recommendations such as preventative measures and steps to help mitigate issues and/or dangerous situations.

FIG. 4C illustrates a diagram of an exemplary implementation of generative and/or predictive outputs from live model 410. Outputs 456 from live model 410 may include various generative text-based messages that may be displayed via visual prompts such as via informational elements 314 on display 132 and/or announced audibly via speakers of vehicle 202. Examples of such messages are provided in connection with FIG. 4C. For example, message 458 may indicate “Your Braking score has improved in each of your last 6 driving sessions-keep up the good work!” A message such as message 458 may be presented after live model 410 has determined that, for a designated amount of driving trips, a user has improved upon certain driving behaviors. Live model 410 may monitor progress over a recent period of time to track improvements made in scores/driving behaviors. Message 460 may indicate “Be sure to keep a safe distance, you are approaching stop-and-go traffic within the next 3 minutes.” A message such as message 460 may be presented after live model 410 has determined that the user has a history of poor scores for braking, and is approaching congested traffic that will likely require frequent braking. The stop-and-go traffic determination in message 460 may be a determination relating to a predictive output from live model 410, where live model 410 has determined based upon one or more factors that stop-and-go traffic is likely to occur. Relatedly, a scenario such as that relating to message 460 may also be a scenario in which live model 410 automatically engages an autonomous control feature such as autonomous braking, for example to assist a driver with known poor braking habits. Message 462 indicates “Excessive speed has been detected for the past 5 minutes. Autonomous driving is now engaged.” A message such as message 462 may be presented after live model 410 has determined that the driver has been consistently exceeding the posted speed limit for a designated period of time, causing the autonomous speed features to assume control. As described herein, the activation/engagement of autonomous features may also be accompanied by visual indicators, such as shown at status symbols 328 in FIG. 3.

In some embodiments, rather than messages 458-462 being contained within the confines of informational elements 314, the messages may be displayed on/at other areas of GUI 134. For example, a very important or urgent message may be overlaid on either or both of interfaces 302 and/or 304, in whole or in part, to increase the likelihood that user 104 will see and pay attention to the message.

In some embodiments, messages 458-462 may be transmitted via text message or email to other individuals. For example, in the case of a teenage driver, messages 458-462 may also be transmitted to a user computing device of the parents of the teenage driver, contemporaneous with their display in vehicle 202. Messages such as 458-462 and the content thereof may be accompanied by additional visual/audible indicators to further apprise the user of the presence and/or content of the messages. For example, for the activation/deactivation of autonomous driving features, any combination of visual and/or audible alerts may be implemented. In one example, prior to message 462 being read aloud, a light indicator may flash a certain color or series of colors. Prior to the words of message 462 being spoken, a special chime or bell may sound, alerting the user that a spoken message will follow. Further, beeps of different speeds/frequencies may be implemented to alert a user to a certain event, such as when backing up close to a detected object, to warn the driver of a potential impact. Similarly, a color indicator may flash yellow than red if an unsafe situation is detected.

Exemplary technical effects of the systems and methods described herein may include, for example: (a) receiving and processing telematics data and other data associated with users, including real-time telematics data and other data associated with users; (b) building, based upon received and processed telematics data and other data, one or more AI/ML models to generate customized driving behavior scores for users, including real-time driving behavior scores; (c) generating and displaying on a user computing device a graphical user interface that includes real-time information relating to driving behavior of users, so users can, in real-time, make adjustments to driving behavior; (d) generating and displaying on a user computing device a graphical user interface that includes real-time information relating to driving conditions, so users can, in real-time, make adjustments to driving behavior in view of the driving conditions; (e) generating and displaying on a user computing device a graphical user interface that combines telematics data, vehicle insight data, and/or external data; (f) utilizing edge computing devices to provide local (e.g., at the edge) data processing and transmission, thereby reducing latency in the processing and transmission of real-time data; (g) utilizing artificial intelligence (AI) and/or machine learning (ML) techniques to generate and adjust AI/ML models wherein the AI/ML models may be used to predict a user's likely driving behaviors and the likelihood of experiencing an accident (e.g., property damage and physical injury as a result of the accident) using those driving behaviors; (h) using predictive modeling and edge computing to provide vehicle and traffic data and driving behavior scores in real-time via includes an entertainment/infotainment system of a vehicle; (i) generating generative outputs from AI models specific to a given usen, based upon received specific user data; (j) generating preferred driving behaviors and driving routes for users based upon received user data; (k) allowing insurance companies to target specific users based upon the determined insurance needs of the users; (1) providing incentives, rewards, discounts, and/or reimbursements to users for following suggested driving behaviors and thereby minimizing risks associated with the routes taken for the users; and/or (m) generating insurance policies and associated premiums based upon learned driving behaviors of users, with minimal input from users (e.g., user computing devices of users transmit user data that is processed and then the insurance policy is transmitted to users without requiring user input).

### Exemplary Computing Device

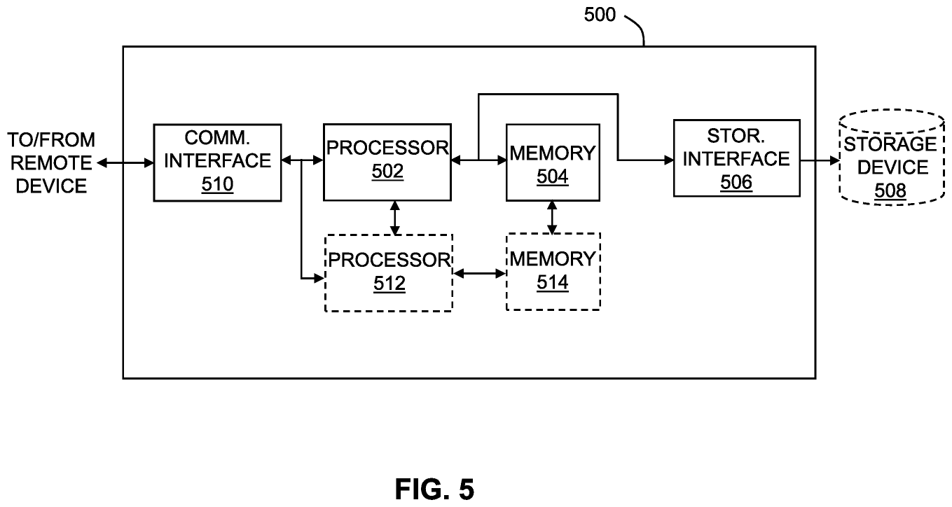

FIG. 5 illustrates an exemplary configuration of a computing device 500, such as RTT computing device 102 and third-party computing devices 112, as shown in FIG.
2 and in accordance with one embodiment of the present disclosure. Computing device 500 may be operated by an operator, such as employee of the company/companies that provide RTT computing device 102 and/or third-party services associated with third-party computing devices 112. Computing device 500 may include a processor 502 for executing instructions. In some embodiments, executable instructions may be stored in a memory area 504. Processor 502 may include one or more processing units (e.g., in a multi-core configuration). Memory area 504 may be any device allowing information such as executable instructions and/or transaction data to be stored and retrieved. Memory area 504, as well as any other memory and/or storage media described in the present disclosure, may include be non-transitory computer readable memory/media.

Computing device 500 may also include a storage interface 506 that may be any component capable of providing processor 502 with access to an optional storage device 508. Storage interface 506 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 502 with access to a storage device 508. For example, server/database 106 may be an embodiment of storage device 508.

Computing device 500 may also include a communication interface 510, which may enable operative communication with a network (e.g., such as network 114 and RTT computing device 102, shown in FIGS. 1 and 2). Communication interface 510 may include, for example, a wired or wireless network adapter and/or a wireless data transceiver for use with a telecommunications network such as an internet and/or mobile telecommunications network.

In some embodiments, computing device 500 may include one or more additional processors 512 that are the same as or similar to processor 502, and one or more additional memory areas 514 that are the same as or similar to memory area 504. Processors 512 and memory areas 514 may be present inside a given computing device 500, and/or embodied in one or more additional operatively connected computing devices 500, such as part of a distributed computing system as described herein, for enabling and implementing parallel processing.

Computing device 500 may include additional, less, or alternate functionality, including that discussed elsewhere herein. Additionally, vehicle computing system 204 of vehicle 202 may have a configuration the same as or similar to the configuration shown in FIG. 5.

### Exemplary Server Device

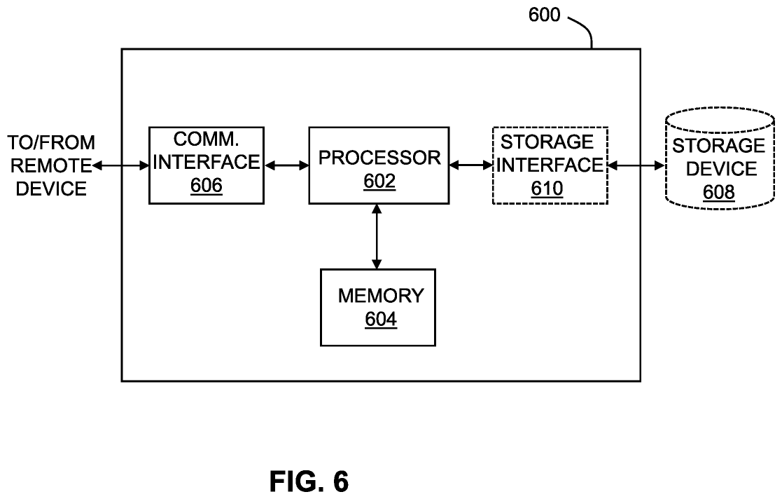

FIG. 6 depicts an exemplary server device 600 such as servers/databases 106 and/or 108, as shown in FIG. 2, and in accordance with one exemplary embodiment of the present disclosure. Server device 600 may include a processor 602 for executing instructions. Instructions may be stored in a memory area 604. Processor 602 may include one or more processing units (e.g., in a multi-core configuration).

Processor 602 may be operatively coupled to a communication interface 606 such that server device 600 may be capable of communicating with a remote computing device. For example, communication interface 606 may receive requests from RTT computing device 102, user computing devices 110, third-party computing devices 112, and/or edge computing system 140 via the Internet and/or over a computer or mobile network.

Processor 602 may also be in operative communication with an optional storage device 608 (e.g., a database of server/database 106 or servers/databases 108, shown in FIG. 2). Storage device 608 may be any computer-operated hardware suitable for storing and/or retrieving data. In some embodiments, storage device 608 may be integrated in server device 600. For example, server device 600 may include one or more hard disk drives as storage device 608. In other embodiments, storage device 608 may be external to server device 600 and may be accessed by a plurality of server devices 600. For example, storage device 608 may include a storage area network (SAN), a network attached storage (NAS) system, and/or multiple storage units such as hard disks and/or solid state disks in a redundant array of inexpensive disks (RAID) configuration.

In some embodiments, processor 602 may be in operative communication with storage device 608 via a storage interface 610. Storage interface 610 may be any component capable of providing processor 602 with access to storage device 608. Storage interface 610 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 602 with access to storage device 608.

Server device 600 may include additional, less, or alternate functionality, including that discussed elsewhere herein. Additionally, edge computing devices 142, 144, and 146 may have a configuration the same as or similar to server device 600.

### Exemplary User Computing Device and Entertainment System

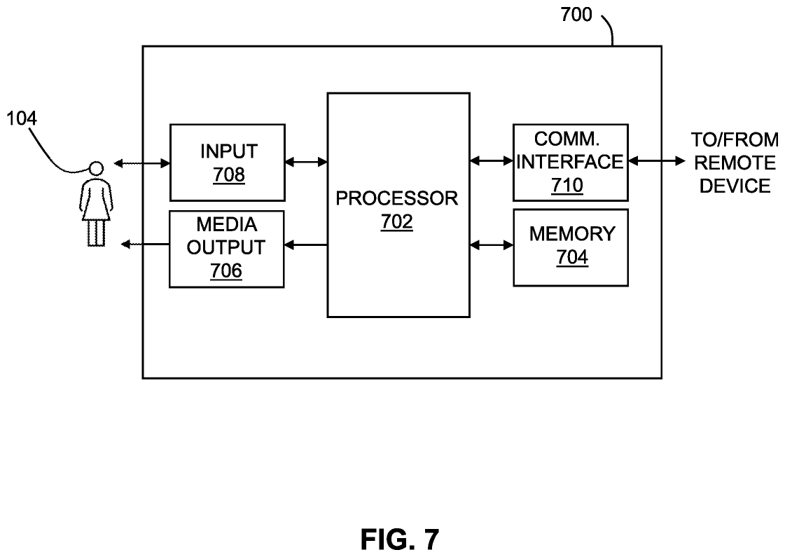

FIG. 7 illustrates an exemplary configuration of an end user computing device 700, such as user computing device 110 and/or vehicle computing system 204 (including display 132) of vehicle 202, as shown in FIG. 2 and in accordance with one embodiment of the present disclosure. End user computing device 700 may be operated by an end user such as user 104. End user computing device 700 may include a processor 702 for executing instructions. In some embodiments, executable instructions may be stored in a memory area 704. Processor 702 may include one or more processing units (e.g., in a multi-core configuration). Memory area 704 may be any device allowing information such as executable instructions and/or transaction data to be stored and retrieved. Memory area 704 may include one or more non-transitory computer readable media.

End user computing device 700 may also include at least one media output component 706 for presenting information to user 104, such as GUI 134 itself and information displayed via GUI 134. Media output component 706 may be any component capable of conveying information to user 104. In some embodiments, media output component 706 may include an output adapter (not shown) such as a video adapter and/or an audio adapter. An output adapter may be operatively coupled to processor 702 and adapted to operatively couple to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 706 may be configured to present a graphical user interface (e.g., GUI 134) to user 104.

End user computing device 700 may also include an input device 708 for receiving input from user 104. User 104 may use input device 708 to, without limitation, make selections within GUI 134, select and/or enter data, such as, for example, user data, an insurance registration form, insurance registration data, etc. Input device 708 may include, for example, a keyboard (digital or physical), a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 706 and input device 708.

End user computing device 700 may also include a communication interface 710, in operative communication with a network (e.g., such as network 114 with respect to user computing device 110, shown in FIGS. 1 and 2). Communication interface 710 may include, for example, a wired or wireless network adapter and/or a wireless data transceiver for use with a telecommunications network such as a mobile telecommunications network, such as for interfacing user computing device 110 with vehicle computing system 204 which may include display 132.

Stored in memory area 704 are, for example, computer readable instructions for providing a user interface such as GUI 134 to user 104 via media output component 706 and, optionally, receiving and processing input from input device 708. A user interface may also include, among other possibilities, a web browser and/or a client application such as app 118. Web browsers and apps enable users, such as user 104, to display and interact with media and other information typically embedded on a web page or a website or within an application. In some embodiments, for example where vehicle 202 is configured itself as an edge computing device, vehicle 202 may include a combination of components shown in FIGS. 5-7.

### Exemplary Computer-Implemented Method for Model

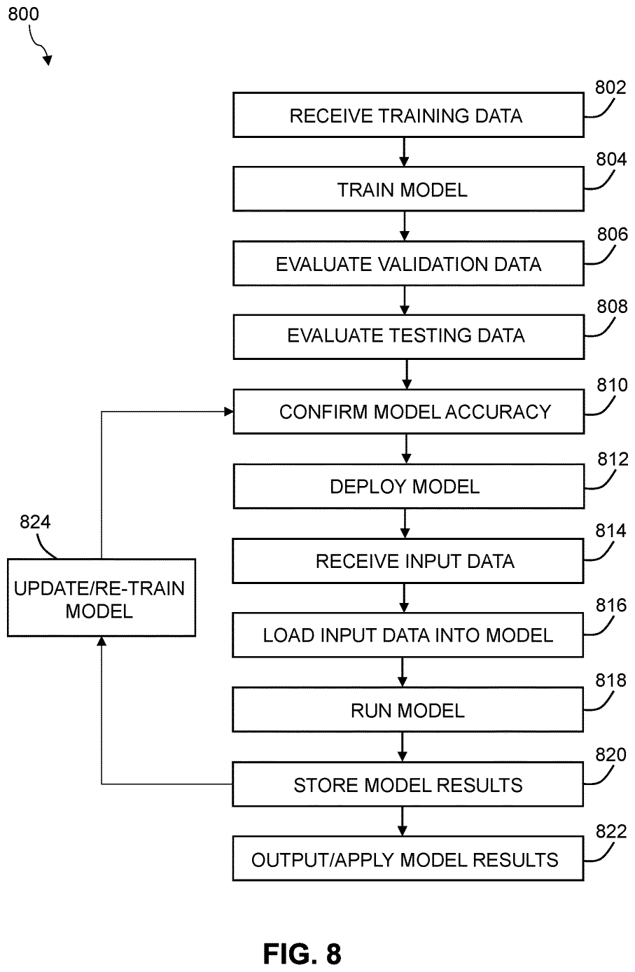

FIG. 8 illustrates a flow chart of an exemplary computer-implemented process 800 for generating a model to analyze user data and for generating real-time driving behavior scores, and/or predictive and generative outputs. Process 800 may be implemented, at least in part, by a computing device/server, for example, RTT computing device 102 and/or server/database 106 (shown in FIGS. 1 and 2).

Process 800 may include receiving 802 (e.g., by RTT computing device 102), from at least one memory (e.g., of and/or in communication with RTT computing device 102), training data that may include a plurality of data records associated with a plurality of users, as described herein such as in described in connection with user data 402 and as shown in FIG. 4A. The plurality of data records may include historical user data as described herein. Process 800 may further include training 804 (e.g., by AI/ML module 210 of RTT computing device 102) a model such as model 116 based upon the plurality of data records. The underlying rules and/or algorithms (e.g., rules and algorithms 406 shown in FIG. 4A) of the model may be based upon relationships that have been determined, over time, to have high correlation with respect to aspects such as driving behavior, accident data, and/or insurance claims, etc. The model may be trained to (i) predict safe, unsafe, and/or risky driving behaviors of a plurality of users based upon such rules and/or algorithms, including accounting for nuanced differences with respect to vehicle types, sizes, geographical driving environments, etc., as described herein, and/or based upon insurance policies and associated premiums, and adjustments thereto, of the plurality of users based upon the historical user data, (ii) analyze and generate for display via a GUI such as GUI 134 information including but not limited to real-time telematics data, including any associated and/or otherwise relevant vehicle insight data and external data, (iii) generate real-time safe driving scores for a plurality of safe driving categories for display via a GUI such as GUI 134 to apprise a user of their real-time driving behavior, and/or (iv) generate predictive and/or generative outputs to further apprise a driver of driving behaviors and/or predicted driving conditions. For example, telematics data may be reflective of a driving style of a user, vehicle insight data may include make, model, weight, stopping distance, safety features, etc., and external data may include weather, traffic/driving conditions, ambient speed, etc. External data such as traffic/driving conditions may be received and/or determined in association with external systems such as real-time traffic cameras that may be positioned adjacent a roadway, as well as smart infrastructure devices such as smart roadside lights, smart toll booths, etc., which may be classified as edge computing devices such as devices 142, 144, and 146, and as part of edge computing system 140.

Process 800 may further include evaluating 806 validation data (e.g., by RTT computing device 102) using the initial trained model, for example for fine-tuning the model, such as for selecting/adjusting hyperparameters, weights, etc. Validation data may include a subset of the training data or data form another source that may be set aside before training (e.g., excluded from the training data). Process 800 may further include evaluating 808 testing data (e.g., by RTT computing device 102) using the trained/validated model. Testing data may include a subset of the training data or data form another source that may be set aside before training and/or validation (e.g., excluded from the training and/or validation data), and may be utilized to provide an unbiased evaluation of the model's performance. Process 800 may further include confirming 810 the accuracy of the model. This may include analyzing the results from validation and testing, and making modifications to the model until a desired accuracy is obtained. For example, steps 806 and 808 may be performed in conjunction with an offline model as described in connection with FIG. 4A.

Process 800 may also include deploying 812 the approved model (e.g., by RTT computing device 102) for use within system 100. This may include making a live version of the model available for use in connection with new input data obtained from real-time driving sessions of users 104, such as described in connection with FIG. 4B. Process 800 may include receiving input data (e.g., from user computing device 110, such as real-time data 452) via a network (e.g., network 114 and/or in association with edge computing system 140 and its devices). Process 800 may further include loading 816 the input data into the model, and running 818 the model with the inputted input data. Process 800 may further include storing 820 results from the running of the model against the input data, such as in a memory of or associated with RTT computing device 102, such as server/database 106 and/or servers/databases 108. The stored data may be used in downstream applications such as for re-training the model. Tables and/or other data structures such as relational databases may be implemented to allow for querying of information to be performed in an efficient manner, such as in connection with the training of model 116. Process 800 may further include outputting/applying results of the model, such as transmitting the results to user computing device 110 so that app 118 processing the model results to generate a graphical display of the results via a GUI such as GUI 134. The model results may include predictive and/or generative prompts, alerts, and/or other notifications as described herein, and may also include real-time driving scores, such as shown in and described in connection with FIG. 3. The outputting/applying of the model results may further be used to determine user driving behavior and any associated preparation and/or validation of an insurance policy and associated premium, and adjustments thereto, for a user. For example, a notification to the user computing device (e.g., user computing device 110) and display via app 118 and/or GUI 134 may include a prompt for the user to “one click” to accept a policy reward (e.g., 10% discount) for continued safe driving as determined based upon the user's scores over a period of time.

Additionally, process 800 may include updating or re-training 824 the model, which may include using new data that has been received and/or new outputs that have been generated since the last-deployed live model for purposes of updating or otherwise modifying and/or re-training the model, as described herein, such as in connection with FIG. 4A. Re-training of the model may include steps similar to steps 804, 806, and 808 utilized during initial training, and confirmation of the accuracy of the re-trained model.

### Exemplary Computer-Implemented Method

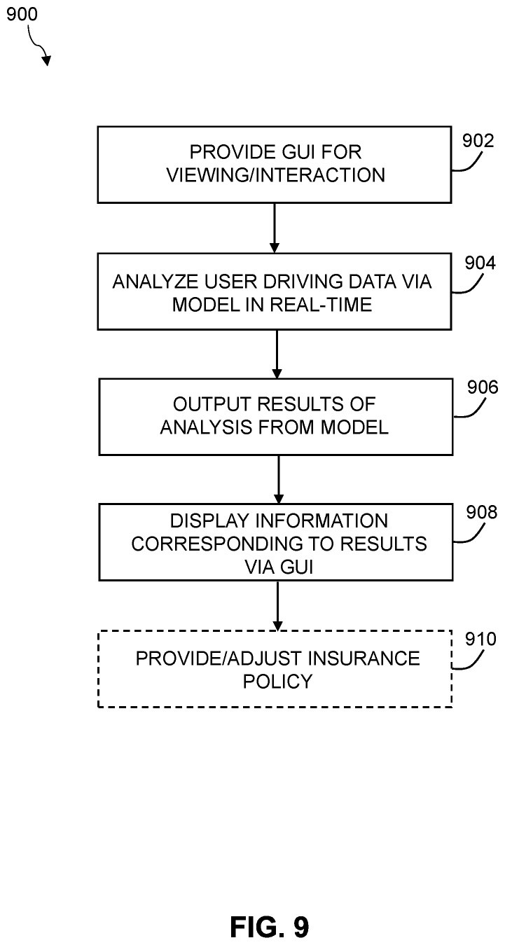

FIG. 9 illustrates a flow chart of an exemplary computer-implemented process 900 for determining driving behavior using a model and providing safe driving scores to users based upon determinations made by the model. Process 900 may also include determining insurance policies and associated premiums, and adjustments thereto, for users based upon the model determinations. Process 900 may be implemented, at least in part, by a computing device/server, for example, RTT computing device 102 (shown in FIGS. 1 and 2) and/or user computing device 110 and via display 132 (e.g., as controlled by vehicle computing system 204).

Process 900 may include providing a GUI such as GUI 134 for viewing/interaction by a user such as user 104 while driving a vehicle such as vehicle 202, for example as provided to display 132 via app 118 of user computing device 110, as described herein. Process 900 may include analyzing 904 user driving data such as telematics data 120 in real-time using one or more models such as model 116. Process 900 may further include outputting 906 results from the analysis of the driving data via the model(s), such as transmitting the results to a mobile phone of a user such as user computing device 110. Process 900 may further include displaying 908 information corresponding to the results of the model via a GUI such as GUI 134. This may include app 118 processing the results from the model(s) and processing and formatting the results for display, such as shown in scoring interface 304 shown in FIG. 3. Process 900 may optionally include providing/adjusting 910 an insurance policy associated with the user, based, for example, on a pattern of sustained safe driving by the user. For example, if user 104 is determined by model 116 to consistently have scores across all monitored safe driving categories that exceed a designated threshold, user 104 may be rewarded with policy discounts and/or other incentives including but not limited to lower premiums, vanishing deductibles, gift cards, periodic bonus checks or other payments, etc. For example, with reference to scores 324 shown in and described in connection with FIG. 3, a user receiving a score of 70 or above in each tracked safe driving category for a defined period of time (e.g., 3 months) may be determined to qualify for an account incentive to reward the user for safe driving behaviors.

In some embodiments, steps 904, 906, and/or 908 may be performed in large part by live model 410 via edge computing devices such as devices 142-146 via edge computing system 140.

### Exemplary Embodiments & Functionality

In one aspect, an edge computing device for generating and displaying real-time driving information relating to operation of a vehicle, the edge computing device being one of a plurality of edge computing devices in network communication within a network, the edge computing device comprising at least one processor in communication with at least one memory device, the at least one processor configured to: receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network; analyze, using at least an artificial intelligence (AI) tool, the real-time driving data to determine a plurality of driving behaviors of the user; based upon the determined plurality of driving behaviors of the user, generate, via the AI tool and at the edge of the network, a plurality of real-time scores including a real-time score for each driving behavior of the plurality of driving behaviors of the user; and transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

Additionally, for any embodiments described herein of this one aspect, the real-time driving data includes one or more of real-time telematics data, real-time vehicle insight data, or real-time external data associated with one or more of the vehicle, a location of the vehicle, or operation of the vehicle by the user.

Additionally, for any embodiments described herein of this one aspect, the plurality of driving behaviors includes one or more of a braking behavior, an acceleration behavior, a speed behavior, a turning behavior, or a distracted driving behavior.

Additionally, for any embodiments described herein of this one aspect, the at least one processor is further configured to: perform an analysis to determine an optimum edge computing device from the plurality of edge computing devices within the network for the processing of the received real-time driving data; and delegate tasks associated with the processing of the received real-time driving data to the determined optimum edge computing device for the determined optimum edge computing device to perform the tasks, wherein the optimum edge computing device is a one of a smart infrastructure device, a smart vehicle, or a smart device.

Additionally, for any embodiments described herein of this one aspect, the AI tool includes an AI model configured to output generative data based upon an analysis of the received real-time driving data, and the at least one processor is further configured to: process the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system. Additionally, in this one aspect, the output generative data includes information pertaining to at least one of an alert or a suggestion associated with at least one driving behavior of the plurality of driving behaviors, wherein a graphical user interface associated with the display is configured to present the at least one of the alert or the suggestion in the user-readable format, and wherein the audio system is configured to communicate the at least one of the alert or the suggestion in the audible format.

Additionally, for any embodiments described herein of this one aspect, the AI tool includes an AI model configured to output predictive data based upon an analysis of the received real-time driving data, and the at least one processor is further configured to: process the output predictive data for transmission to at least one of the user computing device or a vehicle computing system of the vehicle, wherein the processed predictive data relates to at least one of a predicted driving behavior of the user or predicted driving conditions.

Additionally, for any embodiments described herein of this one aspect, the presentation of the plurality of real-time scores to the user includes at least one of (i) displaying each real-time score via a graphical user interface (GUI) displayed on a display, or (ii) communicating each real-time score audibly via an audio system. Additionally, in this one aspect, the AI tool includes a plurality of AI models, wherein the GUI includes a map interface and a score interface and is shared from the user computing device to a vehicle computing system of the vehicle that includes a display for display of the shared GUI, and wherein the at least one processor is further configured to: process (i) generative data output from one AI model of the plurality of AI models and (ii) predictive data output from another AI model of the plurality of AI models for transmission to the user computing device, wherein at least one of the processed generative data or the processed predictive data is configured to be presented as a visual display element of the GUI.

Additionally, for any embodiments described herein of this one aspect, the AI tool includes an AI model, the vehicle is a smart vehicle, and the at least one processor is further configured to: process autonomous control data generated by the AI model for transmission to at least one of the user computing device or the smart vehicle, wherein the at least one of the user computing device or the smart vehicle is configured to, based upon the processed autonomous control data, activate one or more autonomous control features of the smart vehicle such that the smart vehicle is controlled according to the one or more activated autonomous control features. Additionally, in this one aspect, the AI model is configured to generate indicator data corresponding to at least one of a visual indicator or an audible indicator associated with the activation of the one or more autonomous control features, and the at least one processor is further configured to: process the indicator data for transmission to at least one of the user computing device or the smart vehicle, wherein the at least one of the user computing device or the smart vehicle is configured to cause display of the visual indicator or playback of the audible indicator to apprise the user of the activation of the one or more autonomous control features.

In another aspect, a computer-implemented method for generating and displaying real-time driving information relating to operation of a vehicle, the method implemented using an edge computing device of a plurality of edge computing devices in network communication in a network, the edge computing device including at least one processor in communication with at least one memory device, the method comprising: receiving, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network; analyzing, using at least an artificial intelligence (AI) tool, the real-time driving data to determine a plurality of driving behaviors of the user; based upon the determined plurality of driving behaviors of the user, generating, via the AI tool and at the edge of the network, a plurality of real-time scores including a real-time score for each driving behavior of the plurality of driving behaviors of the user; and transmitting, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

Additionally, for any embodiments described herein of this another aspect, the AI tool includes an AI model configured to output generative data based upon an analysis of the received real-time driving data. The computer-implemented method further comprises: processing the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system.

Additionally, for any embodiments described herein of this another aspect, the AI tool includes an AI model configured to output predictive data based upon an analysis of the received real-time driving data. The computer-implemented method further comprises: processing the output predictive data for transmission to at least one of the user computing device or a vehicle computing system of the vehicle, wherein the processed predictive data relates to at least one of a predicted driving behavior of the user or predicted driving conditions.

Additionally, for any embodiments described herein of this another aspect, the computer-implemented method further comprises: presenting the plurality of real-time scores to the user via at least one of (i) displaying each real-time score via a graphical user interface displayed on a display, or (ii) communicating each real-time score audibly via an audio system.

In yet another aspect, at least one non-transitory computer-readable storage medium having computer-executable instructions embodied thereon, wherein when executed by at least one processor in communication with at least one memory device of an edge computing device of a plurality of edge computing devices in network communication in a network, the computer-executable instructions cause the at least one processor to: receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network; analyze, using at least an artificial intelligence (AI) tool, the real-time driving data to determine a plurality of driving behaviors of the user; based upon the determined plurality of driving behaviors of the user, generate, via the AI tool and at the edge of the network, a plurality of real-time scores including a real-time score for each driving behavior of the plurality of driving behaviors of the user; and transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

Additionally, for any embodiments described herein of this yet another aspect, the AI tool includes an AI model configured to output generative data based upon an analysis of the received real-time driving data, and the computer-executable instructions further cause the at least one processor to: process the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system.

Additionally, for any embodiments described herein of this yet another aspect, the AI tool includes an AI model configured to output predictive data based upon an analysis of the received real-time driving data, and the computer-executable instructions further cause the at least one processor to: process the output predictive data for transmission to at least one of the user computing device or a vehicle computing system of the vehicle, wherein the processed predictive data relates to at least one of a predicted driving behavior of the user or predicted driving conditions.

Additionally, for any embodiments described herein of this yet another aspect, the computer-executable instructions further cause the at least one processor to: cause the plurality of real-time scores to be presented to the user via at least one of (i) display of each real-time score via a graphical user interface displayed on a display, or (ii) communication of each real-time score audibly via an audio system. Additionally, in this yet another aspect, the computer-executable instructions further cause the at least one processor to: perform an analysis to determine an optimum edge computing device from the plurality of edge computing devices within the network for the processing of the received real-time driving data; and delegate tasks associated with the processing of the received real-time driving data to the determined optimum edge computing device for the determined optimum edge computing device to perform the tasks, wherein the optimum edge computing device is a one of a smart infrastructure device, a smart vehicle, or a smart device.

### Additional Embodiments & Functionality

Additional embodiments and functionality may include the following.

In one additional embodiment, a computing device for providing assisted vehicle control based upon real-time driving information obtained in connection with operation of a smart vehicle. The computing device may include at least one processor in communication with at least one memory device, and the at least one processor may be configured to receive real-time driving data of a smart vehicle being operated by a user, wherein the real-time driving data may be derived from sensor data of one or more sensors of (i) a user computing device that may be associated with the user and located in the smart vehicle at a time of operation of the smart vehicle by the user, or (ii) the smart vehicle. The at least one processor may be further configured to generate, using at least an artificial intelligence (AI) tool and based upon analysis of the real-time driving data via the AI tool, score data for one or more pre-determined driving categories associated with operation of the smart vehicle. The at least one processor may be yet further configured to determine, for each driving category of the one or more pre-determined driving categories, whether the score data satisfies a corresponding safe driving threshold. The at least one processor may be yet further configured to in response to a determination that the score data for at least one driving category of the one or more pre-determined driving categories does not satisfy the corresponding safe driving threshold, activate one or more autonomous control features of the smart vehicle corresponding to the at least one driving category of the one or more pre-determined driving categories determined to not satisfy the corresponding safe driving threshold.

In any embodiments described herein of the computing device for providing assisted vehicle control based upon real-time driving information obtained in connection with operation of a smart vehicle, the at least one processor may be further configured to determine, for a driving session of the smart vehicle, which of the user or the one or more activated autonomous control features was acting as an operator for each driving category; and attribute the score data for the driving session to the determined operator for each driving category.

In any embodiments described herein of the computing device for providing assisted vehicle control based upon real-time driving information obtained in connection with operation of a smart vehicle, the at least one processor may be further configured to cause presentation of an indicator via at least one of the user computing device or a computing system of the smart vehicle, the indicator configured to apprise the user of activation of the one or more autonomous control features.

In any embodiments described herein of the computing device for providing assisted vehicle control based upon real-time driving information obtained in connection with operation of a smart vehicle, the AI tool may include at least one AI model, and the at least one processor may be further configured to cause presentation of a generative output generated by and output from the AI model to the user via at least one of the user computing device or a computing system of the smart vehicle. The generative output may include information regarding a contextual relationship between (i) the at least one driving category of the one or more pre-determined driving categories that was determined to not satisfy the corresponding safe driving threshold and (ii) activation of the one or more autonomous control features corresponding to the at least one driving category of the one or more pre-determined driving categories determined to not satisfy the corresponding safe driving threshold.

In any embodiments described herein of the computing device for providing assisted vehicle control based upon real-time driving information obtained in connection with operation of a smart vehicle, the one or more pre-determined driving categories may include one or more of a braking category, an acceleration category, a speed category, a turning category, or a distracted driving category, and the one or more autonomous control features includes one or more of braking control, speed control, turning control, or steering control.

In any embodiments described herein of the computing device for providing assisted vehicle control based upon real-time driving information obtained in connection with operation of a smart vehicle, the computing device may be associated with an edge computing system and at least a portion of the real-time driving data may be at least one of (i) transmitted and/or received via a network associated with the edge computing system or (ii) processed at the edge of the network.

In any embodiments described herein of the computing device for providing assisted vehicle control based upon real-time driving information obtained in connection with operation of a smart vehicle, the real-time driving data may include one or more of real-time telematics data, real-time vehicle insight data, or real-time external data associated with one or more of the smart vehicle, a location of the smart vehicle, or the operation of the smart vehicle by the user.

In any embodiments described herein of the computing device for providing assisted vehicle control based upon real-time driving information obtained in connection with operation of a smart vehicle, the at least one processor may be further configured to generate, via the AI tool and based upon the score data, a real-time score for each driving category of the one or more of the pre-determined driving categories and cause each real-time score to be presented to the user via at least one of the user computing device or a computing system of the smart vehicle, to apprise the user of real-time grading of the operation of the smart vehicle by the user for each driving category of the one or more pre-determined driving categories.

In any embodiments described herein of the computing device for providing assisted vehicle control based upon real-time driving information obtained in connection with operation of a smart vehicle, the at least one processor may be further configured to cause presentation of each real-time score to the user via at least one of (i) a display of the user computing device, (ii) a display of the computing system of the smart vehicle, (iii) a speaker of the user computing device, or (iv) a speaker operatively connected with the computing system of the smart vehicle.

In any embodiments described herein of the computing device for providing assisted vehicle control based upon real-time driving information obtained in connection with operation of a smart vehicle, the at least one processor may be further configured to cause presentation of each real-time score via a graphical user interface (GUI) provided on at least one of the user computing device or the computing system of the smart vehicle. Each real-time score may be displayed within a score interface of the GUI.

In any embodiments described herein of the computing device for providing assisted vehicle control based upon real-time driving information obtained in connection with operation of a smart vehicle, the at least one processor may be further configured to for a future driving session, cause at least one autonomous control feature of the one or more autonomous control features of the smart vehicle to be automatically activated at vehicle startup based upon (i) identification of the user and (ii) an output from the AI tool regarding recent historical score data of the user.

In another additional embodiment, a computer-implemented method for providing assisted vehicle control based upon real-time driving information obtained in connection with operation of a smart vehicle. The computer-implemented method may be implemented using a computing device, the computing device may include at least one processor in communication with at least one memory device. The computer-implemented method may include receiving real-time driving data of a smart vehicle being operated by a user, wherein the real-time driving data may be derived from sensor data of one or more sensors of (i) a user computing device that may be associated with the user and located in the smart vehicle at a time of operation of the smart vehicle by the user, or (ii) the smart vehicle. The computer-implemented method may further include generating, using at least an artificial intelligence (AI) tool and based upon analysis of the real-time driving data via the AI tool, score data for one or more pre-determined driving categories associated with operation of the smart vehicle. The computer-implemented method may further include determining, for each driving category of the one or more pre-determined driving categories, whether the score data satisfies a corresponding safe driving threshold. The computer-implemented method may further include in response to a determination that the score data for at least one driving category of the one or more pre-determined driving categories does not satisfy the corresponding safe driving threshold, activating one or more autonomous control features of the smart vehicle corresponding to the at least one driving category of the one or more pre-determined driving categories determined to not satisfy the corresponding safe driving threshold.

In any embodiments described herein of the another additional embodiment for the computer-implemented method for providing assisted vehicle control based upon real-time driving information obtained in connection with operation of a smart vehicle, the AI tool may include at least one AI model, the computer-implemented method may further include causing presentation of a generative output generated by and output from the AI model to the user via at least one of the user computing device or a computing system of the smart vehicle, wherein the generative output includes information regarding a contextual relationship between (i) the at least one driving category of the one or more pre-determined driving categories that was determined to not satisfy the corresponding safe driving threshold and (ii) activation of the one or more autonomous control features corresponding to the at least one driving category of the one or more pre-determined driving categories determined to not satisfy the corresponding safe driving threshold.

In any embodiments described herein of the another additional embodiment for the computer-implemented method for providing assisted vehicle control based upon real-time driving information obtained in connection with operation of a smart vehicle, the computer-implemented method may further include generating, via the AI tool and based upon the score data, a real-time score for each driving category of the one or more of the pre-determined driving categories and causing each real-time score to be presented to the user via at least one of the user computing device or a computing system of the smart vehicle, to apprise the user of real-time grading of the operation of the smart vehicle by the user for each driving category of the one or more pre-determined driving categories.

In any embodiments described herein of the another additional embodiment for the computer-implemented method for providing assisted vehicle control based upon real-time driving information obtained in connection with operation of a smart vehicle, the computer-implemented may further include, for a future driving session, causing at least one autonomous control feature of the one or more autonomous control features of the smart vehicle to be automatically activated at vehicle startup based upon (i) identification of the user and (ii) an output from the AI tool regarding recent historical score data of the user.

In yet another additional embodiment, at least one non-transitory computer-readable storage medium having computer-executable instructions embodied thereon, wherein when executed by at least one processor in communication with at least one memory device of a computing device, the computer-executable instructions may cause the at least one processor to receive real-time driving data of a smart vehicle being operated by a user, wherein the real-time driving data may be derived from sensor data of one or more sensors of (i) a user computing device that may be associated with the user and located in the smart vehicle at a time of operation of the smart vehicle by the user, or (ii) the smart vehicle. The computer-executable instructions, when executed, may further cause the at least one processor to generate, using at least an artificial intelligence (AI) tool and based upon analysis of the real-time driving data via the AI tool, score data for one or more pre-determined driving categories associated with operation of the smart vehicle. The computer-executable instructions, when executed, may yet further cause the at least one processor to determine, for each driving category of the one or more pre-determined driving categories, whether the score data satisfies a corresponding safe driving threshold. The computer-executable instructions, when executed, may yet further cause the at least one processor to in response to a determination that the score data for at least one driving category of the one or more pre-determined driving categories does not satisfy the corresponding safe driving threshold, activate one or more autonomous control features of the smart vehicle corresponding to the at least one driving category of the one or more pre-determined driving categories determined to not satisfy the corresponding safe driving threshold.

In any embodiments described herein for the yet another additional embodiment, the AI tool may include at least one AI model, and the computer-executable instructions, when executed, may further cause the at least one processor to cause presentation of a generative output generated by and output from the AI model to the user via at least one of the user computing device or a computing system of the smart vehicle, wherein the generative output includes information regarding a contextual relationship between (i) the at least one driving category of the one or more pre-determined driving categories that was determined to not satisfy the corresponding safe driving threshold and (ii) activation of the one or more autonomous control features corresponding to the at least one driving category of the one or more pre-determined driving categories determined to not satisfy the corresponding safe driving threshold.

In any embodiments described herein for the yet another additional embodiment, the computing device may be associated with an edge computing system and at least a portion of the real-time driving data is at least one of (i) transmitted and/or received via a network associated with the edge computing system or (ii) processed at the edge of the network.

In any embodiments described herein for the yet another additional embodiment, the computer-executable instructions, when executed, may further cause the at least one processor to generate, via the AI tool and based upon the score data, a real-time score for each driving category of the one or more of the pre-determined driving categories and cause each real-time score to be presented to the user via at least one of the user computing device or a computing system of the smart vehicle, to apprise the user of real-time grading of the operation of the smart vehicle by the user for each driving category of the one or more pre-determined driving categories.

In any embodiments described herein for the yet another additional embodiment, the computer-executable instructions, when executed, may further cause the at least one processor to, for a future driving session, cause at least one autonomous control feature of the one or more autonomous control features of the smart vehicle to be automatically activated at vehicle startup based upon (i) identification of the user and (ii) an output from the AI tool regarding recent historical score data of the user.

As described herein, an edge computing device may include any of edge computing devices 142, 144, 146, and additionally, or alternatively, user computing device 110, vehicle 202, and any third-party computing device 112 that may be configured as an edge computing device. The edge-computing processing tasks described herein may be performed by any of these enumerated devices.

As described herein, vehicle safety features may include traction control and anti-lock brakes, as well as smart safety features present in modern vehicles. Smart safety features may include but are not limited to adaptive cruise control, adaptive headlights, blind spot monitoring, forward collision warning, automatic emergency braking, automatic emergency steering, lane-departure warning, lane centering, rear cross-traffic alerts, smart parking assistance, smart vehicle cameras, driver assist technologies, semi-autonomous and/or autonomous technologies and systems and control, etc. Telematics data as described herein may include sensor outputs relating to these various vehicle safety/smart safety features.

In some embodiments, client computing devices 112 may be third-party computing devices 112 that may be associated with, or part of a computer network associated with, a weather information service, a traffic information service, and/or an edge computing network and/or edge computing devices, or in operative communication with computer systems and/or computer networks of the weather information service, the traffic information service, and/or the edge computing network and/or the edge computing devices. That is, third-party computing devices 112 may be associated with one or more weather information service providers, one or more traffic information service providers, and/or one or more edge computing providers that provides such respective services.

In some embodiments, some or all of any edge computing systems, networks, and/or devices such as edge computing system 140 and its devices 142-146 may be operated by the same entity that operates RTT computing device 102. In other embodiments, some or all of edge computing systems, networks, and/or devices such as edge computing system 140 and its devices 142-146 may be operated by different entities that are separate from the provider and operator of RTT computing device 102, such as local municipalities and/or other public entities and/or other companies.

In some embodiments, a database of server/database 106 may include a plurality of data including user data associated with users 104, location data associated with users 104, telematics data of users 104, sensor data of users 104, insurance data of users 104, etc. User data of users 104 may be generated, sourced, and/or otherwise derived from a plurality data sources including but not limited to account data of users 104 stored by the provider of system 100, and/or data from user computing device 110, etc. Location data of users 104 may be generated, sourced, and/or otherwise derived from a plurality data sources including but not limited to location data from user computing devices 110 and/or location data of the vehicle in which user 104 is driving, in the case where the vehicle may include a standalone location system such as a native GPS system, and/or if the vehicle is a smart vehicle with a location system configured to determine location via edge computing networks, cellular networks, etc. (e.g., via network triangulation). Telematics data of users 104 may be generated, sourced, and/or otherwise derived from a plurality data sources including but not limited to sensor data from user computing devices 110, vehicle sensor data, etc. Sensor data of users 104 may be generated, sourced, and/or otherwise derived from a plurality data sources including but not limited to sensors from user computing devices 110, vehicle sensor data, etc. Insurance data of users 104 may be generated, sourced, and/or otherwise derived from a plurality data sources including but not limited to account data of users 104 stored by the provider of system 100. A database of server/database 106 may be cloud-based, and/or stored remotely from RTT computing device 102. In some embodiments, the database of server/database 106 may be decentralized. While servers of servers/databases 108 are shown as being separate from the various computing devices shown in FIG. 2, the various computing devices may have integrated servers of servers/databases 108.

In some embodiments, vehicles such as vehicle 202 may be smart vehicles and may communicate amongst themselves via wireless protocols. Nearby smart vehicles may be configured to be alerted that a certain other vehicle is operating in an unsafe manner based upon real-time data indicating unsafe operation.

In some embodiments, vehicles such as vehicle 202 may include autonomous driving features (full or partial). Vehicle 202 and/or RTT computing device 102 may determine when autonomous driving would be better suited to use than human operation and vice versa. An autonomous operation status may be shared with nearby vehicles, indicating whether a vehicle is being operated autonomously or by human driver. Autonomous operation may impact determinations made as to the calculation of driving behavior scores and/or other related aspects described herein. For example, scores could be bifurcated and attributed to the operator most responsible (e.g., human or autonomous).

In some embodiments, scoring may be configured to calculate different weighted scores for larger and heavier vehicles such as semi-trucks compared to smaller vehicles that can stop faster, and then that output may be combined with other features of the vehicles such as all-wheel drive, automatic braking, crash detection, and historical claims data for that specific vehicle, and in relation to the location (e.g., city versus rural) and driving conditions (e.g., rain, snow, etc.).

In some embodiments, distraction scoring may be based upon detected events that may include elevated noises within the interior of the vehicle, such as music and/or conversation that is detected at a volume above a certain threshold deemed to correlate to distracted driving. In other embodiments, distraction scoring may be based upon body part (e.g., head, hand, face, and/or torso) tracking data that may be obtained by an interior camera of a vehicle such as vehicle 202, configured to observe a driver's body, and/or (iii) other detected events or occurrences that may be deemed to correlate to distracted driving, such as having a vehicle with passengers in the rear seats. The presence of additional passengers may, for example, be determined by detecting the presence of mobile phones of the passengers. Detecting the presence of other mobile phones inside the vehicle may be determined via Bluetooth, NFC, GPS, cellular triangulation techniques, and/or other location tracking techniques. Additional consideration factors for determining distracted driving may include (i) loud noises outside of the vehicle such as due to sirens and/or construction, and (ii) biometric analysis such as detecting a user's eyes (e.g., pupils) being taken off the road. For example, user computing device 110 may, based upon data associated with a string of recent events, be able to ascertain with a high degree of confidence that a new teenage driver is driving with a car full of friends, listening to loud music, taking turns too hard, and speeding. The results of such determinations may be displayed via GUI 134 and informational elements 314. RTT computing device 102 may be configured to generate a driving report to be sent to parents/guardians providing a summary of scores for a given time period, and/or automatically send alerts to a mobile phone, email account, and/or other contact of parents/guardians regarding score results and/or if a certain score threshold is triggered/crossed. For example, on a scoring scale of 0-100, a very low score such a 5 for distracted driving may trigger an automatic alert to be sent a parent/guardian, the insurance provider, and/or other relevant parties. RTT computing device 102 and/or model 116 may also be programmed to disregard false positive scores so as to not cause unnecessary alerts and/or other downstream events to be triggered/occur. For example, if a score of 5/100 is recorded, an evaluation may be performed to determine if the 5/100 score was a bona fide score or an invalid score such as due to other contributing factors. In such as case, other sensor and/or telematics data may be reviewed to assist with determining valid/invalid scores. Such review may be performed by model 116 alone and/or in conjunction with a human reviewer, or a human reviewer alone. In emergency situations, emergency alerts based upon telematics data indicating a crash may be sent to devices associated with an insurance account of a user and/or other relevant parties.

In some embodiments, GUI 134 may permit various user customization of GUI 134, such as permitting the relative size of each of interfaces 302 and 304 to be adjusted, for example so that map interface 302 occupies a majority of the space on display 132, or vice versa. For example, map interface 302 may be set to be maximized and occupy the entirety of display 132, in which case scoring interface 304 may be “hidden” and may be re-opened or re-displayed by user 104 touching a symbol associated with the hidden scoring interface 304. Customization of GUI 134 by a user may include the option to set, maximize, or minimize certain aspects of GUI 134 such as icon and text size, colors, themes, sounds, etc. GUI 134 may include additional, less, or alternate functionality, including that discussed elsewhere herein.

While FIGS. 1 and 3 depict display 132 alone as displaying GUI 134, in some embodiments, user computing device 110 may be used in place of display 132. In other embodiments, display 132 and/or an associated sensor system of the vehicle may include the same functionality and sensors as user computing device 110. In yet other embodiments, a combination of user computing device 110 and display 132 may be utilized for display and/or sensing purposes, for example so that display 132 primarily displays map/navigation graphics and associated icons while user computing device 110 displays score information (e.g., a “split screen” mode). In some embodiments, vehicle 202 may include computing and communication components such that vehicle 202 may connect to network 114 without relying on user computing device 110. In some embodiments, the functionality provided by user computing device 110 may be fully integrated by vehicle 202 itself. Sensor data may be collected at/by vehicle 202 itself.

In some embodiments, historical user data, may include, for example, historical telematics data generated from one or more telematics sensors associated with users, historical location data associated with users, and historical transaction data between the users and third-parties associated with third-party computing devices 112. Model 116 may analyze current user data (e.g., real-time data 452) and, based upon the analysis, output an insurance plan (e.g., an insurance policy and associated premium) customized for the candidate user. An insurance plan may be transmitted to a client computing device 112 associated with an insurance provider offering the insurance plan to the candidate user for presentation to the user.

In some embodiments, a notification may be transmitted to user computing device 110 of a candidate user by RTT computing device 102. The notification may include terms and conditions, registration rules, and other information associated with using app 118 and/or any insurance plan presented to the user. In some embodiments, the notification may include a pre-populated form that allows the candidate to register for app 118 and/or the insurance policy using a “one-touch” mechanism that may be presented via GUI 134. In some embodiments, RTT computing device 102 may provide a credit to a user toward a subsequent insurance policy payment, a direct deposit to an account of the candidate user, a gift card or prepaid card to be used toward a transaction with a merchant, etc. for persistent safe driving scores over a designated period of time.

In some embodiments, current user data may only include a limited amount of data that may be inputted into the model to generate an appropriate and material output. For example, the current user data may only include an age of the user and a geographic location of where the user lives, and this may be a sufficient amount of input data to generate an accurate output from the model including the driving behaviors that a particular user will likely exhibit. This may be utilized for time savings.

In some embodiments, the models may generate insurance policies and/or revisions and adjustments thereto, as well as rates and premiums for users 104, based upon the driving data and the results of the analysis of the driving data. In some embodiments, a comparison (e.g., by RTT computing device 102) may be performed between a validation insurance policy and another (e.g., base) insurance policy and associated premium for the user based upon the predicted driving behavior to validate the trial user data and complete a validation process. When the validation insurance policy matches the insurance policy and associated premium for the user based upon the predicted driving behavior within a predetermined threshold amount, the trial driving behavior is validated, and the trial insurance policy may be renewed.

Candidate user data may be retrieved by RTT computing device 102 when the candidate user submits an insurance inquiry to receive insurance from an insurance provider associated with RTT computing device 102. That is, the candidate user may opt-in for RTT computing device 102 to retrieve user data when the candidate user submits the insurance inquiry. Additionally, or alternatively, the candidate user data may be retrieved from databases in communication with RTT computing device 102, such as servers/databases 106 and/or 108. For example, the candidate user may opt-in for third parties to share data with RTT computing device 102 when the candidate user utilizes the third-party services without specifically opting-in with RTT computing device 102.

RTT computing device 102 may build and train model 116 using a learning data set such as user data 402. The learning data set includes historical user data for a plurality of users and for a plurality of vehicles, trips, etc. Learning data also may include accident reports associated with users. Accident reports include data associated with a traffic related accident, such as location and time of accident, weather conditions, traffic conditions, and costs associated with personal injury and property damage. The learning data set may also include data associated with successful trips performed using the one or more modes of transportation. RTT computing device 102 may determine and/or calculate one or more parameters that will be included in the learning data. For example, RTT computing device 102 may determine for trip, a ratio of the number of successful trips to the number of trips resulting in an accident. RTT computing device 102 may include this ratio in the learning data set. Learning data, utilized by RTT computing device 102 includes any data suitable to build and train the model.

In some embodiments, user driving information for the plurality of users may be stored without including sensitive personal information, also known as personally identifiable information or PII, in order to ensure the privacy of individuals associated with the stored data. PII may include any information capable of identifying an individual. For privacy and security reasons, personally identifiable information may be withheld from the user accounts or profiles. In some examples where privacy and security can otherwise be ensured, or where individuals consent, PII may be retained in the user information. In such examples, personally identifiable information may be needed to create enhanced driving behavior assessments. In situations in which the systems described herein collect personal information about individuals including passengers in vehicles, or may make use of such personal information, the individuals may be provided with an opportunity to control whether such information is collected or to control whether and/or how such information is used. In addition, certain data may be processed in one or more ways before it is stored or used, so that personally identifiable information is removed. For example, an individual's identity may be processed so that no personally identifiable information can be determined for the individual, or an individual's geographic location may be generalized where location data is obtained (e.g., such as to a city, ZIP code, or state level), so that a particular location of an individual cannot be determined. Thus, the individual may have control over how information is collected about the individual and used by systems including the user computing device.

In some embodiments, RTT computing device 102 may receive data from third-party sources, and app 118 may use or include an application programming interface (“API”) for integration with third-party data, services, platforms, accounts, and the likes.

In some embodiments, vehicle data may include vehicle build information for vehicles manufactured by a plurality of original equipment manufacturers (OEMs). The vehicle build information may contain OEM-specific terminology associated with one or more features associated with vehicles manufactured by the OEMs, such as for various safety features of the vehicles. The vehicle build information may be utilized by RTT computing device 102 as part of generating models 116, for example to generate an ontology model that maps each safety feature to any OEM-specific terminology associated with the safety features for each OEM. The ontology model may be applied to the vehicle build information to generate converted vehicle build information for vehicles that do not rely on OEM-specific terminology and/or to harmonize similar safety features based upon their technical features rather than a designated OEM-specific name. The ontology model may be configured to generate and use a set of common terms for common safety features that may have different OEM-specific names. For example, for a safety feature such as a smart seat belt, one OEM may refer to such a feature as a “smart assist belt” whereas a different OEM may refer to such a feature as a “smart detection seat belt.” By converting the OEM-specific terminology to non-OEM specific terminology, the model may be better able to make determinations based upon the safety features regardless of any OEM-specific terminology.

In some embodiments, user 104 may use app 118 in a vehicle while not being the driver. App 118 may have a feature to allow user 104 to indicate, or self-report, that a particular driving trip was not actually performed by the user, but by another person. These types of driving trips may be disregarded and not attributed to user 104 when it comes to analyzing the trip and/or with respect to the individualized model of user 104. System 100 may also be configured to be able to determine such scenarios automatically via technological analysis. For example, RTT computing device 102 may be able to determine from sensor data of a smart watch (e.g., a smart device 146) of user 104 that user 104 is not actually driving. RTT computing device 102 may refer to a plurality of sensor outputs to make such a determination with a threshold level of confidence. If the result of the analysis is that it is unclear if user 104 was actually driving, a prompt or message may be sent to user 104 asking for confirmation is a particular driving trip should be attributed to user 104.

### Artificial Intelligence, Machine Learning & Other Matters

The systems and computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models (e.g., driving and/or traffic models, which may be part of a single model or be separate models) may be created based upon example inputs in order to make valid and reliable predictions for novel inputs.

Additionally or alternatively, the ML programs may be trained by inputting sample data sets or certain data into the programs, such as vehicle telematics data, and/or industry accident and repair/medical data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The ML learning programs may also include natural language processing, semantic analysis, automatic reasoning, and/or other ML techniques.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

Edge computing situates compute resources, logic, and/or data storage closer to the devices where the data may be being gathered and/or used, reducing latency issues, and improving an application's ability to provide data in real time. By using such a configuration, fewer processes are run in the central network sites such as a cloud and are instead moved local, for example to local edge computing infrastructure which may include smart street lights and/or smart vehicles, a user's computing device, and/or an edge server, and the like. In edge computing, the “edge of the network” refers to the point where a local network or device connects to the broader Internet, essentially acting as a gateway between local computing resources and the wider network. Put another way, the “edge of the network” is where data is generated and/or consumed, and is considered the boundary where devices interact directly with the Internet, allowing for faster processing closer to the data source. By pushing more compute workloads to the edge, AI/ML intelligence processing may be able to be conducted at the edge without requiring connections to central network sites (or with minimized connections to the central network sites), and with reduced latency and/other benefits as described herein. Any servers/databases described herein and used in connection with providing real-time scores and/or generative/predictive outputs from models may be cloud-based for improved usage in edge computing tasks, and in connection with could-based AI aspects described herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program may be provided, and the program may be embodied on a computer readable medium. In an example, the system may be executed on a single computer system, without requiring a connection to a server computer. In a further example embodiment, the system may be run in a Windows® environment (Windows is a registered trademark of Microsoft Corporation, Redmond, Washington). In yet another embodiment, the system may be run on a mainframe environment and a UNIX® server environment (UNIX is a registered trademark of X/Open Company Limited located in Reading, Berkshire, United Kingdom). In a further embodiment, the system may run on an iOS® environment (iOS is a registered trademark of Cisco Systems, Inc. located in San Jose, CA). In yet a further embodiment, the system may run on a Mac OS® environment (Mac OS is a registered trademark of Apple Inc. located in Cupertino, CA). In still yet a further embodiment, the system may run on Android® OS (Android is a registered trademark of Google, Inc. of Mountain View, CA). In another embodiment, the system may run on Linux® OS (Linux is a registered trademark of Linus Torvalds of Boston, MA). The application may be flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that may be stored in a computer system. The above examples are not intended to limit in any way the definition and/or meaning of the term database. Examples of RDBMS's include, but are not limited to, Oracle® Database, MySQL, IBM@ DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In some embodiments, the system includes multiple components distributed among a plurality of computing devices. In one embodiment, the system includes a plurality of virtual computing devices (e.g., virtual machines) in a cloud configuration, such that the virtual computing devices may be dynamically allocated. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An edge computing device for generating and displaying real-time driving information relating to operation of a vehicle, the edge computing device being one of a plurality of edge computing devices in network communication within a network, the edge computing device comprising at least one processor in communication with at least one memory device, the at least one processor configured to:
receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network;
analyze, using at least an artificial intelligence (AI) tool, the real-time driving data to determine a plurality of driving behaviors of the user;
based upon the determined plurality of driving behaviors of the user, generate, via the AI tool and at the edge of the network, a plurality of real-time scores including a real-time score for each driving behavior of the plurality of driving behaviors of the user; and
transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

2. The edge computing device of claim 1, wherein the real-time driving data includes one or more of real-time telematics data, real-time vehicle insight data, or real-time external data associated with one or more of the vehicle, a location of the vehicle, or operation of the vehicle by the user.

3. The edge computing device of claim 1, wherein the plurality of driving behaviors includes one or more of a braking behavior, an acceleration behavior, a speed behavior, a turning behavior, or a distracted driving behavior.

4. The edge computing device of claim 1, wherein the at least one processor is further configured to:
perform an analysis to determine an optimum edge computing device from the plurality of edge computing devices within the network for the processing of the received real-time driving data; and
delegate tasks associated with the processing of the received real-time driving data to the determined optimum edge computing device for the determined optimum edge computing device to perform the tasks, wherein the optimum edge computing device is a one of a smart infrastructure device, a smart vehicle, or a smart device.

5. The edge computing device of claim 1, wherein the AI tool includes an AI model configured to output generative data based upon an analysis of the received real-time driving data, and the at least one processor is further configured to:
process the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system.

6. The edge computing device of claim 5, wherein the output generative data includes information pertaining to at least one of an alert or a suggestion associated with at least one driving behavior of the plurality of driving behaviors, wherein a graphical user interface associated with the display is configured to present the at least one of the alert or the suggestion in the user-readable format, and wherein the audio system is configured to communicate the at least one of the alert or the suggestion in the audible format.

7. The edge computing device of claim 1, wherein the AI tool includes an AI model configured to output predictive data based upon an analysis of the received real-time driving data, and the at least one processor is further configured to:
process the output predictive data for transmission to at least one of the user computing device or a vehicle computing system of the vehicle, wherein the processed predictive data relates to at least one of a predicted driving behavior of the user or predicted driving conditions.

8. The edge computing device of claim 1, wherein the presentation of the plurality of real-time scores to the user includes at least one of (i) displaying each real-time score via a graphical user interface (GUI) displayed on a display, or (ii) communicating each real-time score audibly via an audio system.

9. The edge computing device of claim 8, wherein the AI tool includes a plurality of AI models, wherein the GUI includes a map interface and a score interface and is shared from the user computing device to a vehicle computing system of the vehicle that includes a display for display of the shared GUI, and wherein the at least one processor is further configured to:
process (i) generative data output from one AI model of the plurality of AI models and (ii) predictive data output from another AI model of the plurality of AI models for transmission to the user computing device, wherein at least one of the processed generative data or the processed predictive data is configured to be presented as a visual display element of the GUI.

10. The edge computing device of claim 1, wherein the AI tool includes an AI model, the vehicle is a smart vehicle, and the at least one processor is further configured to:
process autonomous control data generated by the AI model for transmission to at least one of the user computing device or the smart vehicle, wherein the at least one of the user computing device or the smart vehicle is configured to, based upon the processed autonomous control data, activate one or more autonomous control features of the smart vehicle such that the smart vehicle is controlled according to the one or more activated autonomous control features.

11. The edge computing device of claim 10, wherein the AI model is configured to generate indicator data corresponding to at least one of a visual indicator or an audible indicator associated with the activation of the one or more autonomous control features, and the at least one processor is further configured to:
process the indicator data for transmission to at least one of the user computing device or the smart vehicle, wherein the at least one of the user computing device or the smart vehicle is configured to cause display of the visual indicator or playback of the audible indicator to apprise the user of the activation of the one or more autonomous control features.

12. A computer-implemented method for generating and displaying real-time driving information relating to operation of a vehicle, the computer-implemented method implemented using an edge computing device of a plurality of edge computing devices in network communication in a network, the edge computing device including at least one processor in communication with at least one memory device, the computer-implemented method comprising:
receiving, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network;
analyzing, using at least an artificial intelligence (AI) tool, the real-time driving data to determine a plurality of driving behaviors of the user;
based upon the determined plurality of driving behaviors of the user, generating, via the AI tool and at the edge of the network, a plurality of real-time scores including a real-time score for each driving behavior of the plurality of driving behaviors of the user; and
transmitting, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

13. The computer-implemented method of claim 12, wherein the AI tool includes an AI model configured to output generative data based upon an analysis of the received real-time driving data, the computer-implemented method further comprising:
processing the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system.

14. The computer-implemented method of claim 12, wherein the AI tool includes an AI model configured to output predictive data based upon an analysis of the received real-time driving data, the computer-implemented method further comprising:
processing the output predictive data for transmission to at least one of the user computing device or a vehicle computing system of the vehicle, wherein the processed predictive data relates to at least one of a predicted driving behavior of the user or predicted driving conditions.

15. The computer-implemented method of claim 12, further comprising:
presenting the plurality of real-time scores to the user via at least one of (i) displaying each real-time score via a graphical user interface displayed on a display, or (ii) communicating each real-time score audibly via an audio system.

16. At least one non-transitory computer-readable storage medium having computer-executable instructions embodied thereon, wherein when executed by at least one processor in communication with at least one memory device of an edge computing device of a plurality of edge computing devices in network communication in a network, the computer-executable instructions cause the at least one processor to:
receive, via the network, real-time driving data of a vehicle being operated by a user, wherein the real-time driving data is derived from sensor data of at least one or more sensors of a user computing device that is (i) associated with the user and located in the vehicle at a time of operation of the vehicle by the user, and (ii) configured to transmit the real-time driving data to the edge computing device via the network;
analyze, using at least an artificial intelligence (AI) tool, the real-time driving data to determine a plurality of driving behaviors of the user;
based upon the determined plurality of driving behaviors of the user, generate, via the AI tool and at the edge of the network, a plurality of real-time scores including a real-time score for each driving behavior of the plurality of driving behaviors of the user; and
transmit, via the network and at the edge of the network, score data corresponding to the generated plurality of real-time scores to at least one of the user computing device or the vehicle, wherein the at least one of the user computing device or the vehicle is configured to receive and process the score data for presentation of the plurality of real-time scores to the user, to apprise the user of the real-time score for each driving behavior during the user's operation of the vehicle.

17. The at least one non-transitory computer-readable storage medium of claim 16, wherein the AI tool includes an AI model configured to output generative data based upon an analysis of the received real-time driving data, and the computer-executable instructions further cause the at least one processor to:
process the output generative data for transmission to at least one of the user computing device or a vehicle computing system of the vehicle, wherein at least one of the user computing device or the vehicle computing system is configured to cause real-time presentation of the processed generative data to the user during operation of the vehicle by the user via at least one of (i) a user-readable format displayed via a display, or (ii) an audible format played via an audio system.

18. The at least one non-transitory computer-readable storage medium of claim 16, wherein the AI tool includes an AI model configured to output predictive data based upon an analysis of the received real-time driving data, and the computer-executable instructions further cause the at least one processor to:
process the output predictive data for transmission to at least one of the user computing device or a vehicle computing system of the vehicle, wherein the processed predictive data relates to at least one of a predicted driving behavior of the user or predicted driving conditions.

19. The at least one non-transitory computer-readable storage medium of claim 16, wherein the computer-executable instructions further cause the at least one processor to:
cause the plurality of real-time scores to be presented to the user via at least one of (i) display of each real-time score via a graphical user interface displayed on a display, or (ii) communication of each real-time score audibly via an audio system.

20. The at least one non-transitory computer-readable storage medium of claim 16, wherein the computer-executable instructions further cause the at least one processor to:
perform an analysis to determine an optimum edge computing device from the plurality of edge computing devices within the network for the processing of the received real-time driving data; and
delegate tasks associated with the processing of the received real-time driving data to the determined optimum edge computing device for the determined optimum edge computing device to perform the tasks, wherein the optimum edge computing device is a one of a smart infrastructure device, a smart vehicle, or a smart device.
